(19) United States
(12) Patent Application Publication
(10) Pub. No.: US 2019/0004802 A1
(43) Pub. Date: Jan. 3, 2019

(54) PREDICTOR FOR HARD-TO-PREDICT BRANCHES

(71) Applicant: Intel Corporation, Santa Clara, CA (US)

(72) Inventors: Stephen J. Tarsa, Cambridge, MA (US); Gokce Keskin, Sunnyvale, CA (US); Gautham N. Chinya, Portland, OR (US); Hong Wang, Santa Clara, CA (US)

(21) Appl. No.: 15/637,562

(22) Filed: Jun. 29, 2017

(51) Int. Cl. G06F 9/38; G06N 3/04

(52) U.S. Cl. CPC G06F 9/3806; G06N 3/04

(57) ABSTRACT

A processor, including: an execution unit including branching circuitry; a branch predictor, including a hard-to-predict (HTP) branch filter to identify an HTP branch; and a special branch predictor to receive identification of an HTP branch from the HTP branch filter, the special branch predictor including a convolutional neural network (CNN) branch predictor to predict a branching action for the HTP branch.

### FIELD OF THE SPECIFICATION

This disclosure relates in general to the field of semiconductor devices, and more particularly, though not exclusively, to a system and method for predicting hard to predict branches.

### BACKGROUND

Multiprocessor systems are becoming more and more common. In the modern world, compute resources play an ever more integrated role with human lives. As computers become increasingly ubiquitous, controlling everything from power grids to large industrial machines to personal computers to light bulbs, the demand for ever more capable processors increases.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of selected elements of a branch predictor according to one or more examples of the present specification.

FIG. 2 is a mathematical flow diagram illustrating two-layer convolutional neural network (CNN) according to one or more examples of the present specification.

FIG. 3 is a block diagram illustrating application of a CNN to a branch prediction problem according to one or more examples of the present specification.

FIG. 4 is a block diagram illustration of a training set according to one or more examples of the present specification.

FIG. 5 is a block diagram of a branch predictor model according to one or more examples of the present specification.

FIGS. 6 and 7 are block diagrams of CNN branch predictors according to one or more examples of the present specification.

FIG. 8 is a block diagram of a special branch prediction apparatus and method according to one or more examples of the present specification.

FIGS. 9a-9b are block diagrams illustrating a generic vector-friendly instruction format and instruction templates thereof according to one or more examples of the present specification.

FIGS. 10a-10d are block diagrams illustrating an example specific vector-friendly instruction format according to one or more examples of the present specification.

FIG. 11 is a block diagram of a register architecture according to one or more examples of the present specification.

FIG. 12a is a block diagram illustrating both an example in-order pipeline and an example register renaming an out-of-order issue/execution pipeline according to one or more examples of the present specification.

FIG. 12b is a block diagram illustrating both an example of an in-order architecture core and an example register renaming an out-of-order issue/execution architecture core to be included in a processor according to one or more examples of the present specification.

FIGS. 13a-13b illustrate a block diagram of a more specific in-order core architecture, which core would be one of several logic blocks (including other cores of the same type and/or different types) in a chip according to one or more examples of the present specification.

FIG. 14 is a block diagram of a processor that may have more than one core, may have an integrated memory controller, and may have integrated graphics according to one or more examples of the present specification.

FIGS. 15-18 are block diagrams of computer architectures according to one or more examples of the present specification.

FIG. 19 is a block diagram contrasting the use of a software instruction converter to convert binary instructions in a source instruction set to binary instructions in a target instruction set according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Branch prediction is a key contributor to contemporary microprocessor performance. Even a very fast microprocessor with a highly capable pipeline and a large cache can grind to a near halt in the case of a branch misprediction. A branch misprediction can interrupt the program flow, result in the pipeline having to be reset, may result in having to refill the cache from slow main memory, and may have other performance impacts.

Existing hardware branch predictors achieve high accuracy for many types of conditional branches. This accuracy can be on the order of 98 to 99% or better. However, the pattern recognition mechanisms of traditional branch predictors systematically underperform on a certain subset of hard to predict (HTP) branches. These HTP branches may arise, for example, from program structures that cause a high degree of variation in the history data used for branch prediction. These HTP branches are difficult for traditional branch predictors, such as partial pattern matching branch predictors, because those may be based on recognizing exact sequences, also known as perceptrons, that capture positional correlations.

Because even 1 to 2% branch misprediction can incur severe performance penalties in a microprocessor, it is advantageous to provide supplemental branch prediction circuitry, such as a special branch predictor, that provides algorithms focused on certain types of HTP branch predictions. The special branch predictor may be provided directly in processor hardware, in microcode, may be implemented in supplemental software, or may be encoded within a hardware accelerator, such as a field-programmable gate array (FPGA), application-specific integrated circuit (ASIC), or co-processor.

In certain embodiments, an HTP branch filter may be used to filter branching sequences, to determine whether the branch should be predicted by a mainline branch predictor, which may use traditional methods such as partial pattern matching (PPM), or should be sent to a special branch predictor which may use a more sophisticated branch prediction algorithm. Examples of the present specification include a special branch predictor that uses a convolutional neural network (CNN) to perform better branch prediction on HTP branches.

In general, branch predictors work by performing pattern recognition on branch history data, and conditioning the probability that a branch is taken on the observed program state. Embodiments of such a branch predictor may include both learning to train a data model for runtime statistics, and making inferences to generate new predictions from that model. A successful branch predictor may balance the accuracy of both functions against the data, storage, and computation constraints of operating at the front end of a pipeline.

Highly tuned and optimized mainline branch predictors, employing for example PPM, are capable of predicting on the order of 98 to 99% or better of branches. However, the remaining 1 to 2% of branch mispredictions can cause significant performance impacts, as the entire execution pipeline may need to be flushed, and the penalty increases proportionally with machine width and the costs of misprediction.

Thus, a special branch predictor as described herein may provide a helper function that can improve the accuracy of HTP branches using a CNN. CNNs are useful for capturing patterns from noisy, high variation data. A CNN hierarchically combines position in sensitive pattern matching at lower layers with position-specific matching at higher layers to improve tolerance to data variations like pattern shifts. Conditional statements inside variable iteration count loops, or other program structures like switch statements, may cause such variations within the history data, and thus give rise to an HTP branch. Thus, certain of these structures may be more usefully modeled with a CNN then by PPM.

The special branch predictor of the present specification is configured to augment a mainline or baseline predictor in high performance use cases. This is particularly relevant in high-performance computing (HPC), where applications execute thousands of times across thousands of machines. This is also useful in cases of widely distributed software that can be run many times on a large variety of heterogeneous computing devices. Embodiments of the present specification identify HTP branches in runtime data, stream their history data to a special branch predictor, which may be embodied in some cases in a coprocessor or FPGA, and train the CNN in the special branch predictor. The special branch predictor can then compute helper predictor metadata from trained networks, and cache and reuse results for an application-specific performance boost.

Certain embodiments of the present special branch predictor may require as little as the seven least significant bits of a program counter (PC) value from path histories, thus making it agnostic to the base virtual address at which an application is loaded for execution. Furthermore, prediction gains can be held for traces lasting for one billion instructions, thus illustrating that the CNN-based special branch predictor extracts stable predictive patterns.

A training module may train a CNN per hard to predict branch, offline from the branch predictor, and then distribute metadata containing precomputed network responses to an on-chip special branch predictor, such as a coprocessor or FPGA. The training module may target use cases were stable application behaviors can be learned offline and used to improve binaries distributed at a large scale, thus amortizing the training costs over time and across many different systems. As discussed above, the CNN of the present specification may be resilient to aliasing when PC addresses are masked to as few as the least significant six or seven bits during training, which enables this method to tolerate changes in the base virtual address between application executions without retraining. In cases where a programmer modifies source code and releases a new binary, the network may be retrained, and metadata may be updated to boost application performance. In some cases, this process may be automated, requiring no expert knowledge of program analysis, and can be provided as a service by, for example, a vendor of the microprocessor.

Multilayer CNNs may implement pattern matching in branch history data in flexible ways. CNNs apply a small set of learned filters in many positions (i.e., convolutionally) to detect key patterns that are subject to distortion like positional shifts. In contrast, perceptrons may learn simpler position dependent correlations in a branch's prior history. These may be less tolerant to data variations that are not linearly separable. Thus, the CNN branch predictor is particularly useful in cases where branches depend on program structures that are poorly predicted by perceptrons and PPM predictors, such as when a branch is preceded by a loop whose iteration count changes throughout execution, causing predictive patterns to shift position in global history data.

The branch predictor of the present specification uses a multilayer CNN that is optimized to make on-chip inference feasible without requiring heavy front-end computations at prediction time. Specifically, when network topology and weight precision are restricted during training, convolutional filter responses may be precomputed and pipelined to reduce later on-chip predictions to a single binary inner product.

Embodiments of a 1-bit CNN predictor may be trained offline using full-precision backpropagation with binary constraints, such as following a four-step procedure:
1. Identify candidate HTP branches under a baseline predictor in a client workload.
2. Build a training set of history data per HTP branches.
3. Train a 1-bit CNN predictor via backpropagation on a dedicated platform.
4. Extract network responses and upload them as metadata to an on-chip special branch predictor.

Metadata carrying precomputed convolutional filter responses and network parameters may first be distributed to client machines and installed in an on-chip special branch predictor dedicated to HTP branches, providing an application-specific performance boost. This training and distribution process may be automated and provided as a service to clients executing performance sensitive binaries at large scales.

The CNN of the present specification implements multilayer convolutional pattern matching using learned filters, to recognize patterns that are subject to distortion and positional variations within noisy data. This situation often occurs in history data for a significant portion of branches on which traditional PPM, perceptron, and domain-specific predictors underperform.

However, the computational complexity of both CNN training and inferences may be a barrier to implementing a full CNN as a helper predictor on-chip or in an FPGA. Thus, embodiments of the present disclosure may target cases where CNN predictors can be trained offline for individual hard to predict branches, and where the associated costs can be amortized by sustained performance improvements over time on applications distributed at a large scale. Examples include bundling branch prediction metadata with binaries for an application-specific IPC boost, or providing a cloud-based optimization service for customers deploying performance sensitive barriers to many machines in a data center.

To address the complexity of CNN inferences when making on-chip predictions, embodiments of the present specification provide optimizations that arise from a specific choice of data encoding, network topology, and weight constraints imposed during network training. Using these, network parameters and precomputed filter responses may be extracted from a trained CNN and installed in a single on-chip special branch predictor. The special branch predictor may be invoked only for HTP branches in a specific application, and may produce predictions that are algebraically equivalent to feedforward CNN inferences using a small number of logic and integer operations.

This is beneficial, because it has been found that the accuracy of CNNs in vision and audio classification tasks often degrades only slightly when the precision of their parameters is severely restricted. Thus, embodiments of the present specification provide a CNN-based branch predictor that requires 4,000 bits of on-chip storage per HTP branch, and only parallel exclusive-or (XOR), accumulate, shift, integer multiply, and subtract operations to generate a prediction.

When trained on the same branch history data, CNNs may perform highly flexible pattern matching.

A traditional perceptron predictor multiplies an end dimensional vector of global history bits (e.g., representing the directions of the prior end branches) against an n×1 weight vector, and thresholds the result to make a prediction. Weight vectors may be learned for each branch being predicted and capture statistical correlations between bits in each position of a branch's global history and its direction.

In contrast, the special branch predictor of the present specification uses convolution to perform pattern matching that is purposefully insensitive to position shifts in history data. This is because common program structures naturally cause patterns to shift position in global histories, for example when varying iteration loops can cause two correlated branches to be separated by an unpredictable number of interim bits in the global history.

A system and method for predicting hard to predict branches will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

Certain of the figures below detail example architectures and systems to implement embodiments of the above. In some embodiments, one or more hardware components and/or instructions described above are emulated as detailed below, or implemented as software modules.

In certain examples, instruction(s) may be embodied in a “generic vector-friendly instruction format,” which is detailed below. In other embodiments, another instruction format is used. The description below of the write mask registers, various data transformations (swizzle, broadcast, etc.), addressing, etc. is generally applicable to the description of the embodiments of the instruction(s) above. Additionally, example systems, architectures, and pipelines are detailed below. Embodiments of the instruction(s) above may be executed on those systems, architectures, and pipelines, but are not limited to those detailed.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are fewer fields included) and/or defined to have a given field interpreted differently. Thus, each instruction of an ISA is expressed using a given instruction format (and, if defined, in a given one of the instruction templates of that instruction format) and includes fields for specifying the operation and the operands.

In one embodiment, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

A set of SIMD extensions referred to as the advanced vector extensions (AVXs) (AVX1 and AVX2), and using the vector extensions (VEX) coding scheme has been released and/or published (e.g., see Intel® 64 and IA-32 Architectures Software Developer's Manual, September 10014; and see Intel® Advanced Vector Extensions Programming Reference, October 10014).

Example Instruction Formats

Embodiments of the instruction(s) described herein may be embodied in different formats. Additionally, example systems, architectures, and pipelines are detailed below. Embodiments of the instruction(s) may be executed on such systems, architectures, and pipelines, but are not limited to those detailed.

Generic Vector-Friendly Instruction Format

A vector-friendly instruction format is an instruction format that is suited for vector instructions (e.g., there are certain fields specific to vector operations). While embodiments are described in which both vector and scalar operations are supported through the vector-friendly instruction format, alternative embodiments use only vector operations through the vector-friendly instruction format.

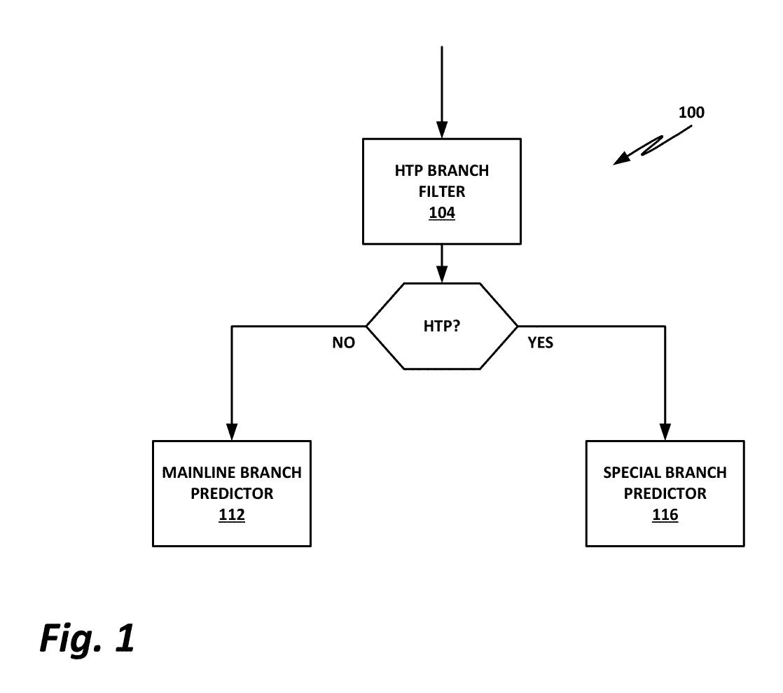

FIG. 1 is a block diagram of selected elements of a branch predictor 100 according to one or more examples of the present specification. In the illustration, branch predictor 100 includes an HTP branch filter 104. HTP branch filter 104 examines upcoming branches to determine whether they should be classified as an HTP branch. If the branch is not an HTP branch, then the branch may be predicted according to traditional methods, such as PPM or perceptrons, according to mainline branch predictor 112.

However, if the branch is determined to be an HTP branch, then it may be sent to special branch predictor 116. Special branch predictor 116 may be in some embodiments a coprocessor or FPGA, or an on-die circuit, that provides special branch prediction according to the methods discussed herein. In particular, special branch predictor 116 may employ a two-layer CNN method as described herein.

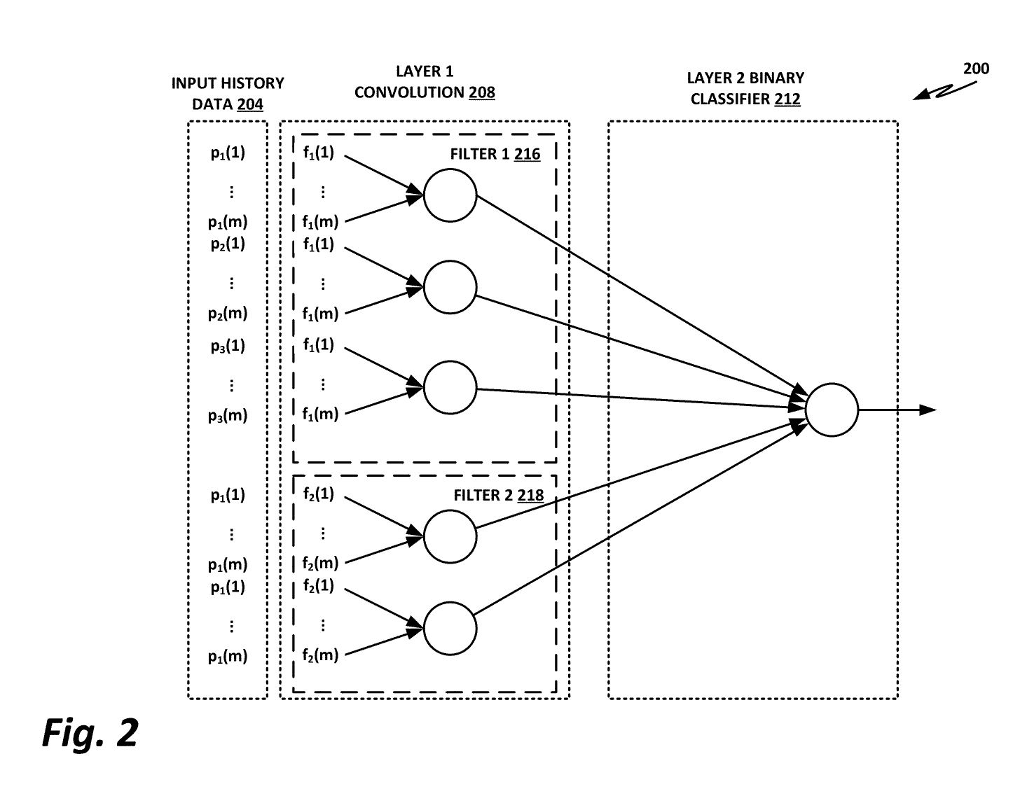

FIG. 2 is a mathematical flow diagram illustrating two-layer CNN according to one or more examples of the present specification. In this example, input history data 204 are provided to layer 1 convolution 208, which finally provides its results to layer 2 binary classifier 212.

CNN 200 of FIG. 2 maintains multiple single-bit precision weight vectors, each called a binary filter, and matches them against every position in a global history using a binary inner product. In contrast to the perceptron formulation where weight values represent position-specific correlations between branches, the binary filters of CNN 200 are formulated to act as position-agnostic pattern detectors. In this model, detection results are fed to a second CNN layer, specifically layer 2, for binary classification that captures position-specific patterns.

In this example, input history data 204 includes P, meaning m×n 1-hot matrix of history data.

In layer 1 208, each filter is applied convolutionally to all end positions in the history. In layer 2 212, predictions are made from predicted patterns.

A 1-bit CNN 200 can exploit a 1-hot encoding of inputs, together with convolution and 1-bit weight constraints, to mitigate the large storage space that may be required for a PPM predictor, which can grow multiplicatively with the space of possible inputs. CNN 200 maps n-length histories of (PC, direction) pairs to indices of an m×n binary matrix, with a 1 in the (i, j)th position if token i appears in history j, and zeros otherwise (i.e., a matrix with 1-hot columns). Since inner products with a 1-hot vector produce a single non-zero value, all layer 1 convolutions for 1 binary filters can be performed using lookups of that value in an m*L*1 bit table. Storage thus scales by O(m*L*1) rather than O(n*m*b) for a perceptron with b-bit integer weights with L«than n and 1«than b.

This simplification is specific to the combination of 1-hot encoding, convolution, and 1-bit weight constraints found in CNN 200, and makes it possible to speed predictions using the calculations discussed below with reasonable on-chip storage demands. Particularly, to perform pattern matching on the same history of (PC, direction) pairs, the difference is that a CNN may employ 4,000 bits of storage for a 155-length history using 9 least significant bits (LSBs) of the PC and one direction bit per position, versus 952,320 bits for a traditional perceptron with 6 bit integer weights.

In CNN 200, the results of layer 1 convolution 208 are fed to layer two sigmoid or softmax predictor in layer 2 classifier 212, constrained to have binary input weights. Layer 2 212 captures position-specific relationships among layer 1 filter responses, and can exploit fast binary inner product computations. As discussed below, since table lookups for layer 1 filter responses can be pipelined as data arrives, a prediction ultimately may require only parallel XOR, accumulation, shift, integer, multiply, and subtract operations to compute layer 2's response and generate a new prediction. This procedure is significantly simpler and more accurate than the speculative accumulations that may be needed to pipeline integer inner products in path-driven perceptrons.

A majority of branch mispredictions arise systematically. For example, the following code snippet illustrates two HTP branches:

int f(int k, int *uvec, int *vvec)
{
int val1 = 0; int val2 = 0;
/* H2P −1 */
if (uvec [k] % 3 == 0) val1 += 1;
/* Variable Iteration Loop */ for (int i = 0; i < (vvec[k] %

10); i++) if (rand( ) % 2 > 0) val2 += vvec [i];

/* H2P −2 */ if (val1 > 0) return val2;
return 0;
I

While HTP 1 is data dependent, HTP 2 is exactly correlated to HTP 1's outcome. Both are biased to be taken 33% of the time, and are separated by a loop with a variable number of iterations. Although HTP 1 ensures that the global history contains a predictive pattern for HTP 2, uncorrelated branches inserted between these correlated branches by the loop cause the relative positions in history data to change each time a prediction is needed for HTP 2. This is an example of a shift variation. Ideally, with no additional information on data values, HTP 1 should be predicted at least 66% of the time accurately, while HTP 2 should be predicted with 100% accuracy.

However, traditional branch predictors may fail to meet these ideals. Though the global history predictor stores statistics for HTP 2 in every one of its history tables to capture sequences of increasing length, all but 35 predictions over 10,000 function calls on randomized data come from the branch's estimated bias. In certain cases, as many as ten uncorrelated branches separating HTPs lead to an explosion of unique history patterns that must be memorized by the predictor.

The variable iteration loop in this code sample also limits the effectiveness of a perceptron predictor. Variations like pattern shifts can arise naturally from common program structures, and these may undermine exact match and position-specific data models. In the case of PPM, the number of patterns that may appear grows exponentially with history length in the worst case, thus reducing the likelihood that a stored pattern will accumulate confident statistics and be called upon to generate predictions. Depending on table allocation policy, such data may also cause a large amount of non-predictive patterns to be stored in global tables. For position-specific predictors like perceptrons, shift variations keep weights from consistently filtering out noise and preserving predictive correlations.

As discussed above, the CNN-based special branch predictor of the present specification provides a solution to provide better branch prediction in such cases.

The basic unit of a CNN is a neuron, which computes a function ƒ on a linear combination of an N-long real-valued input vector xᵢ and a weight vector (Wᵢ, b):

$$out = f ( ( {\sum }_{i = 1 ... N} {W}_{i} * {x}_{i}$$

Common choices for ƒ are sigmoid, tan h, or a rectified linear unit, and may be chosen per application. Once trained, weight vectors are often called features or filters, since they take on values corresponding to useful patterns learned from the data.

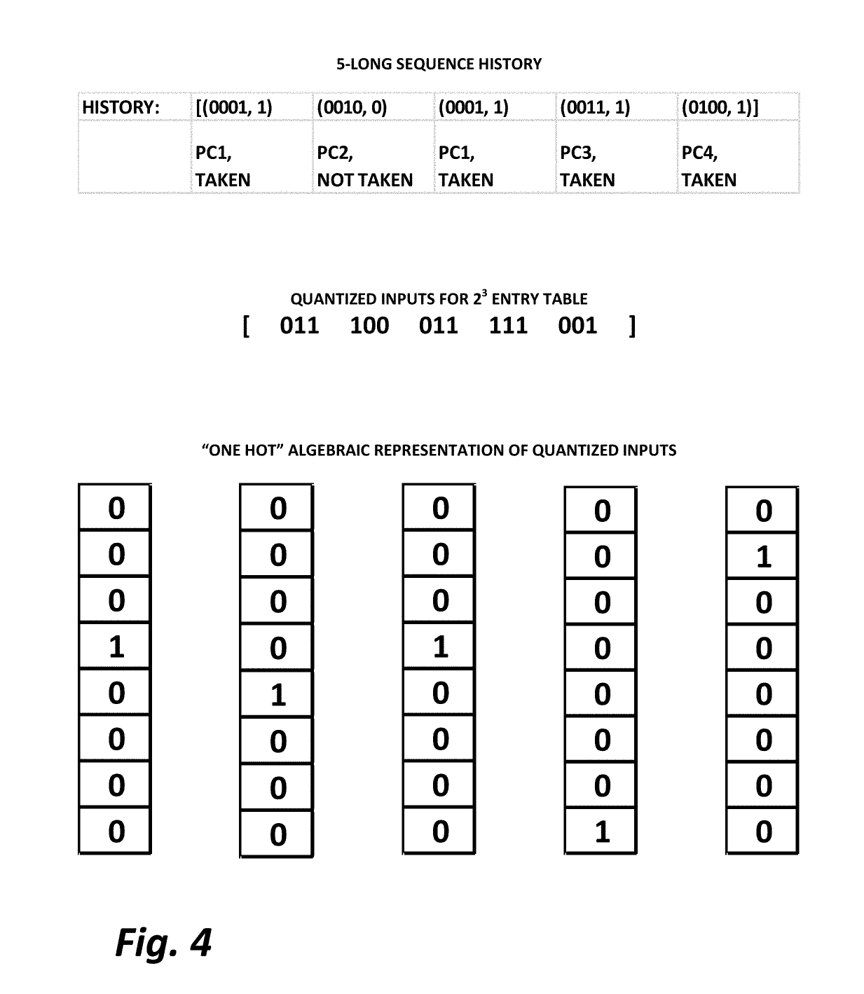

In contrast to perceptron branch predictors that include only a single neuron, CNNs derive their predictive power from layers of neurons stacked on top of each other. At lower layers, neuron weights are trained to yield a small set of filters that can detect salient patterns in any position. Filters have a width of l<<N, which corresponds to the size of the pattern detected by that neuron. Each filter is matched convolutionally to sets of l input values, starting at each position in the input data. This is illustrated in FIG. 4.

Pooling operations and nonlinear choices for ƒ are often applied to lower-layer convolutional filter responses to propagate only strong responses to higher-layer neurons, thus improving their tolerance to shift variation and confounding information.

For example, in the previous code sample, HTP 1 was separated from HTP 2 by a varying number of conditional branches due to a variable iteration count loop. This program structure challenges PPM predictors because of the large number of possible sequences that must be tracked. Single perceptron predictors also struggle because the positional variation of these HTPs present position-specific weights from being tuned to properly capture the predictive signal.

However, the CNN special branch predictor of the present specification may learn a convolutional filter that produces a large inner product score according to equation 1, when matched with the LSBs of HTP 1's PC and its direction. As a result, the convolutional layer of a CNN may properly identify the predictive pattern no matter where it appears in the global history, and propagate only that information to higher levels.

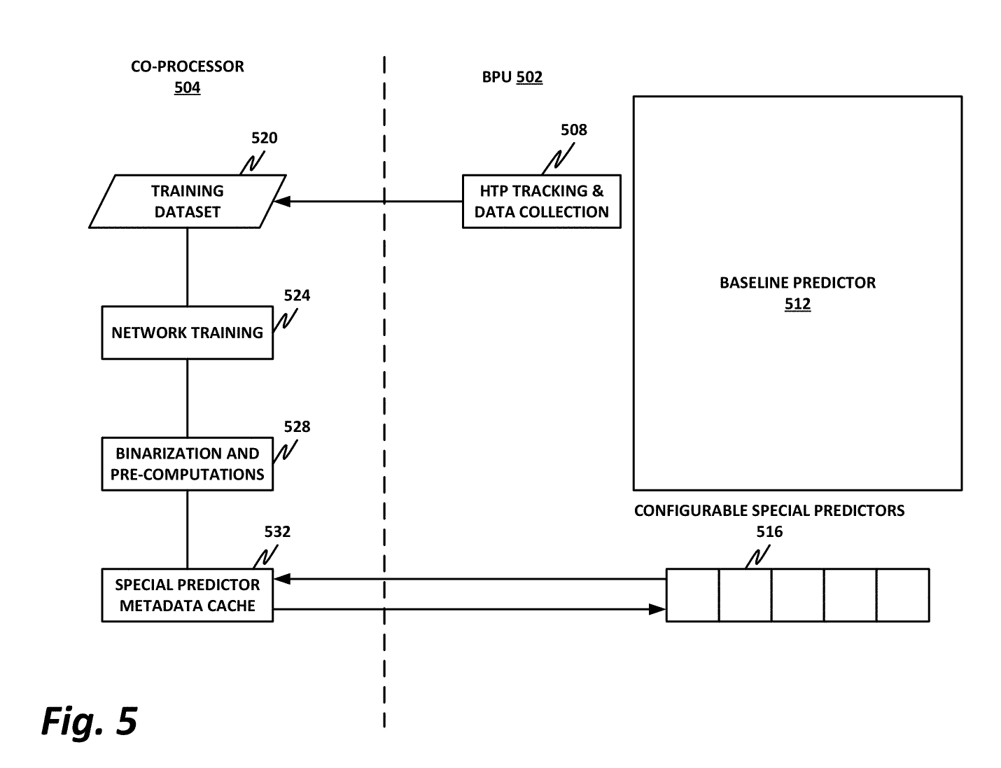

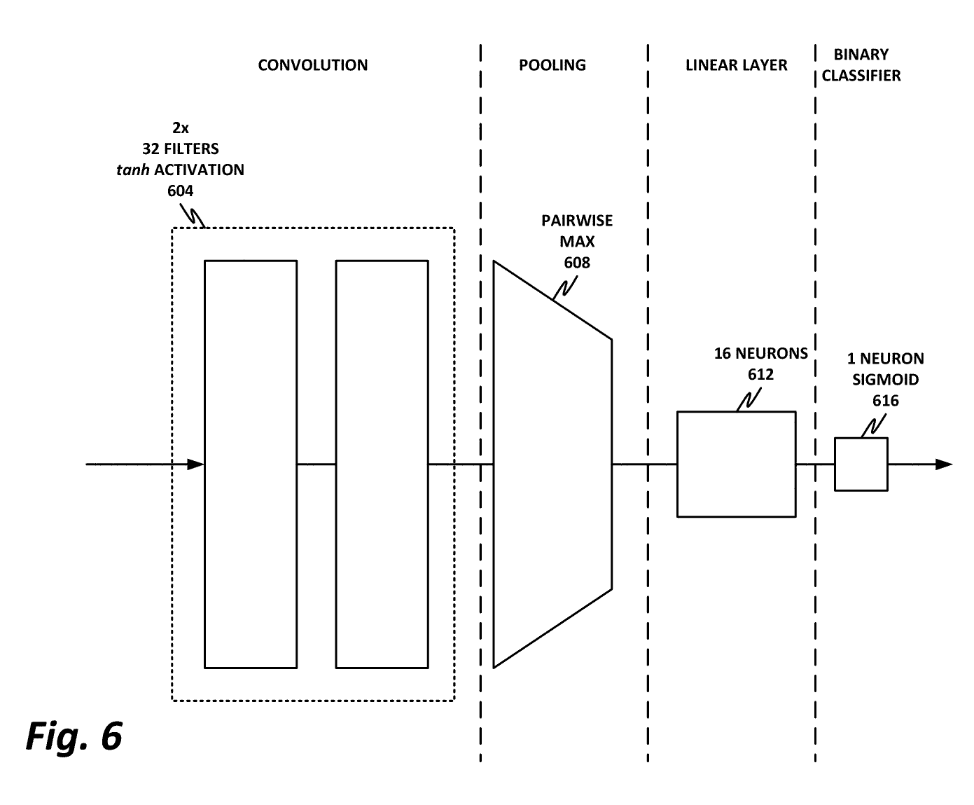

CNN filters may be trained by tuning weights and network parameters based on a data set of example histories and observed branch directions. In an example, there may be recorded batches of branch history data, and backpropagation algorithms may be used to tune weights. Networks may be instantiated per HTP by first choosing the number of layers, filter sizes, and neuron types. One embodiment may then randomly initialize weights and run stochastic gradient dissent, an implementation of backpropagation, to iteratively update parameter values until the top layer's prediction accuracy converges. This is illustrated with greater particularity in connection with FIGS. 5 and 6.

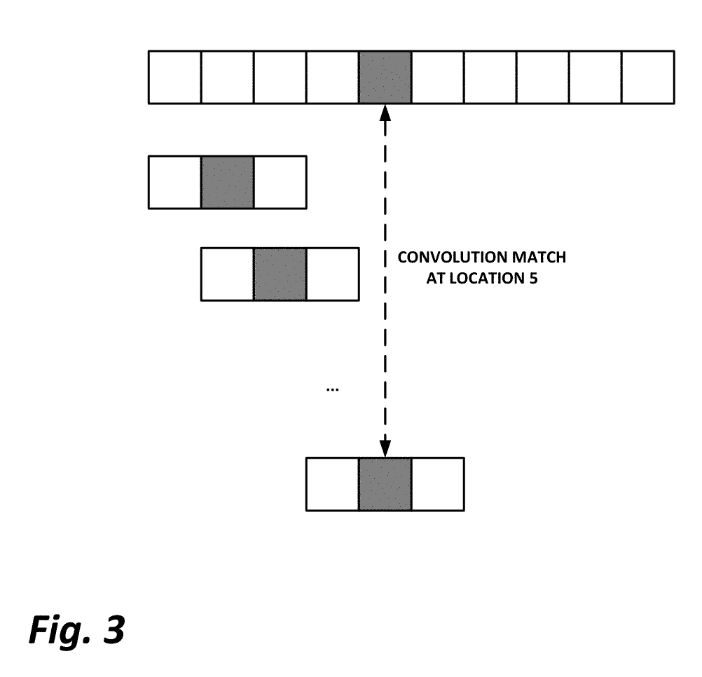

FIG. 3 is a block diagram illustrating application of a CNN to a branch prediction problem according to one or more examples of the present specification.

CNNs may provide excellent pattern recognition even when neuron weights are constrained to be only one bit, taking on values of +1 or −1. The result can greatly simplify inference for trained CNNs by replacing floating-point arithmetic with logical operations, while sacrificing only a modest drop in accuracy. A binary inner product between {−1, +1}N vectors can be computed by XORing their bits, computing a popcount, a level shift, and an integer subtract.

During training, binary constraints may be imposed by maintaining a full precision network, but algebraically ensuring that it will produce the same predictions when weights are quantized. During the forward pass of training, network error is computed as if weights were binary; weights may then be adjusted during the backward pass according to that error.

Because backpropagation adjusts weight values using small steps toward a convergence point, a high precision version of the network may be used during training. Thus, embodiments of the present specification assume that the binary CNN is trained offline from a baseline predictor unit as illustrated in FIG. 5, where high precision computations can be performed. Once trained, networks can be simplified for performing fast inference within the branch predictor unit (BPU).

Training a 1-Bit CNN Predictor

A CNN predictor may be trained per HTP branch, and in some embodiments employs a full precision backpropagation. Training may be implemented offline from the branch predictor unit, and results may be uploaded to an on-chip special branch predictor. Embodiments of the training process may include the following four operations:
1. Identify candidate hard to predict branches.
2. Build a training data set for backpropagation.
3. Train a CNN predictor using backpropagation with binary weight constraints.
4. Extract network responses and upload to an on-chip special branch predictor.

Each of these four operations is described by way of example in its own subheading below.

Identifying Candidate Hard to Predict Branches

In one embodiment, an HTP branch is defined as a branch generating more than 1,000 mispredictions per 30 million instructions, or a branch which is predicted with less than 99% accuracy under a baseline predictor.

Screening for these branches may be done either with additional instrumentation aboard a client machine, or offline by replaying a binary on a simulator or virtual machine.

Candidate HTP branches may also be screened to ensure that a training set of at least 15,000 branch executions is required. This is a conservative estimate of the amount of data required for a 1-bit CNN predictor with eight binary filters to converge during backpropagation, and in one embodiment was established empirically.

Building a Training Data Set for Backpropagation

Backpropagation employs a training set of branch histories, alongside branch outcomes. In one example, sequences of (PC, direction) pairs are recorded for every branch leading up to the HTP branch under study. Each sequence may be of a parameterized length N, for example 155. The HTP branch's direction is also recorded. To encode history data into input suitable for a CNN, the training module may map input values to 1-hot vectors.

Each value in this history may be represented by a vector whose dimension is proportional to the number of possible unique input values. The vector contains a 1 in the position indexed to the corresponding input value, and a zero, otherwise.

FIG. 4 is a block diagram illustration of a training set according to one or more examples of the present specification. In the example of FIG. 4, a 5-long history sequence is shown, including some least significant bits of the PC, and a flag for taken or not taken. These inputs are quantized for a 2³ entry table. A 1-hot algebraic representation of quantized inputs is then recorded.

During encoding, the training module masks history values to control the maximum dimension of 1-hot vectors, and ultimately the storage required to hold precomputed values on-chip. This masking procedure also provides tolerance to changes in the base virtual address of a program between executions, without retraining. For each (PC, direction) pair, the trainer concatenates the (b−1) least significant bits of the PC with the associated 1-bit direction (0: not taken, 1: taken). Each value in the input history data is therefore encoded as a 2^{b}×1 vector with a 1 in the (PC and (2^{b}−1)+direction)th position and zeros otherwise.

An input history sequence of length 155 leading up to an HTP branch is therefore represented as a (2^{b}×155) dimension matrix of 1-bit values. This procedure guarantees that all tuples in history data can be mapped to one of 2^{b} entries in a final lookup table.

Train a CNN Predictor Using Backpropagation with Binary Weight Constraints

For each HTP branch, the trainer may transfer its training data set to a platform dedicated to CNN predictor training. This platform may be a coprocessor on a client machine, or a dedicated server in a cloud environment, by way of nonlimiting example.

Aboard a training platform, the trainer performs standard backpropagation using stochastic gradient descent (SGD) with the added constraints that network weights and activations must use 1-bit of precision. In one embodiment, training may be implemented using open source tools for GPU-accelerated backpropagation with binary constraints.

In some embodiments, the trainer may constrain network topology to allow only binary N-D convolutions as the lowest network layers, since they enable inference computations be pipelined. Linear layers enable no such pipelining, and are therefore used only for the upper layers of the network. The final layer classifier may be implemented during training as a standard full precision classifier (e.g., a sigmoid or softmax). Since values flowing to the classifier are guaranteed to be integers, the classification computation can be closely approximated on-chip using integer operations. One embodiment implements thresholding, batch normalization, and quantization units between each layer to maintain equivalence between the full precision network used for training and the eventual 1-bit CNN used for inference. An example two-layer network with four convolutional filters may be used.

Extracting Network Responses and Uploading Meta Data to an On-Chip Special Predictor

Once the network has been trained, the data encodings may be leveraged to precompute values for convolutional layers, as well as parameters needed by the final layer classification to make a prediction.

The metadata extracted and uploaded to the on-chip special predictor may include, by way of nonlimiting example:
An m×L table, indexed into by a (PC, direction) pair masked to m bits, with each entry containing L 1-bit convolutional filter responses
Two L×n bit layer 2 binary filters, for history length n
Two integer constants used in layer 2 binary inner products
Two scaling constants used to compute a prediction from layer 2 filter responses.

Though all filters are algebraically represented by values −1/+1 in the network formulation, they may be stored on-chip as individual bits with a value of 0 or 1, and appropriate algebraic adjustments may be figured into inner product computations.

The precomputed layer 1 filter table may be populated according to the following formula (assuming learned parameters of the post-layer 1 normalization units according to x_bar=gamma₁*(x−mu₁)/sigma₁²+beta₁)

bool(ƒⱼ(i)+cⱼ>=thresh₁)
for j=1 . . . L; i=1 . . . 2ₘ

with learned bias constants c and thresh₁=ceil(sigma₁*(−beta₁)/gamma₁)+mu₁.

Layer 2 constants that are used to collapse normalization, thresholding, and binary inner products into as few computations as possible are given by:

$$\frac{pred {mux}_{taken} = round ( \frac{1}{{γ}_{taken} / {σ}_{taken}} )}{pred {add}_{taken} = round ( - ( {μ}_{taken} \times {σ}_{taken} ) + {β}_{taken}}$$

Finally, given learned layer 2 filters hₜₐₖₑₙ and hₙₒₜₜₐₖₑₙ and bias constants cₜₐₖₑₙ and cₙₒₜₜₐₖₑₙ, scaling constants are:

$${T}_{taken} = \frac{n \times L + {C}_{taken}}{pred {mux}_{taken} + pred {add}_{taken}}$$

$${T}_{nottaken} = \frac{n \times L + {C}_{taken}}{pred {mux}_{nottaken} + pred {add}_{nottaken}}$$

FIG. 5 is a block diagram of a branch predictor model according to one or more examples of the present specification. In this embodiment, the branch predictor model includes a coprocessor 504 and a branch prediction unit (BPU) 502. In the model of FIG. 5, it may be assumed that HTPs are identified from runtime data in that history data are streamed to coprocessor 504 for training. By way of example, this model may be used to train a single CNN per HTP, and cache the results. The network parameters can then be loaded into BPU 502, to provide an application-specific boost alongside a baseline predictor such as mainline branch predictor 112. Thus, it should be understood that in certain embodiments, BPU 502 of FIG. 500 may be an embodiment of special branch predictor 116 of FIG. 1.

In one nonlimiting example, the first 100 million instructions of a software package or benchmark are screened to identify HTPs. HTPs can be discovered at any point in a workload. However, in this embodiment the scope of the screen is restricted to maximize the amount of evaluation data available in fixed-length traces.

For each HTP identified in the first 100 million instructions, history data are collected from the entire workload including the directions and PC values for the prior 200 conditional branches.

For 1-hot history encoding, each input sample used for training starts as a raw sequence of global path history data leading up to the HTP fetch instruction. Each item in the sequence of 200 contains a (PC, direction) pair, which may be converted into a vector to feed to a CNN. Because PCs are discrete and may take a large number of possible values, each value in a history may be mapped to a 1-hot vector of fixed dimension. For example, setting the dimension according to 2^{b}=1024, the direction bit may be concatenated onto the b−1 LSBs of the PC, and a 1 may be placed in position (PC«1)+Dir Λ(b−1) of a 2^{b}×1 dimensional vector, and zeros otherwise.

By arranging these column vectors into a matrix, a 200-length history may be converted into a 2^{b}×200 matrix representing a single training sample. Though the matrix size is relatively large, the interim data representation may be optimized away during inference.

With reference to FIG. 5, the HTP tracking and data collection operations described in the preceding paragraphs are embodied in block 508. These may be provided to coprocessor 504 as training data set 520. As described in the preceding paragraphs, network training block 524 may perform the training on the training data set.

In block 528, binarization of the training data is performed and pre-computations are performed.

In block 532, a special branch predictor metadata cache is created, and provided to configurable special predictors 516.

Baseline predictor 512 may use configurable special predictors 516 to perform real-time branch prediction.

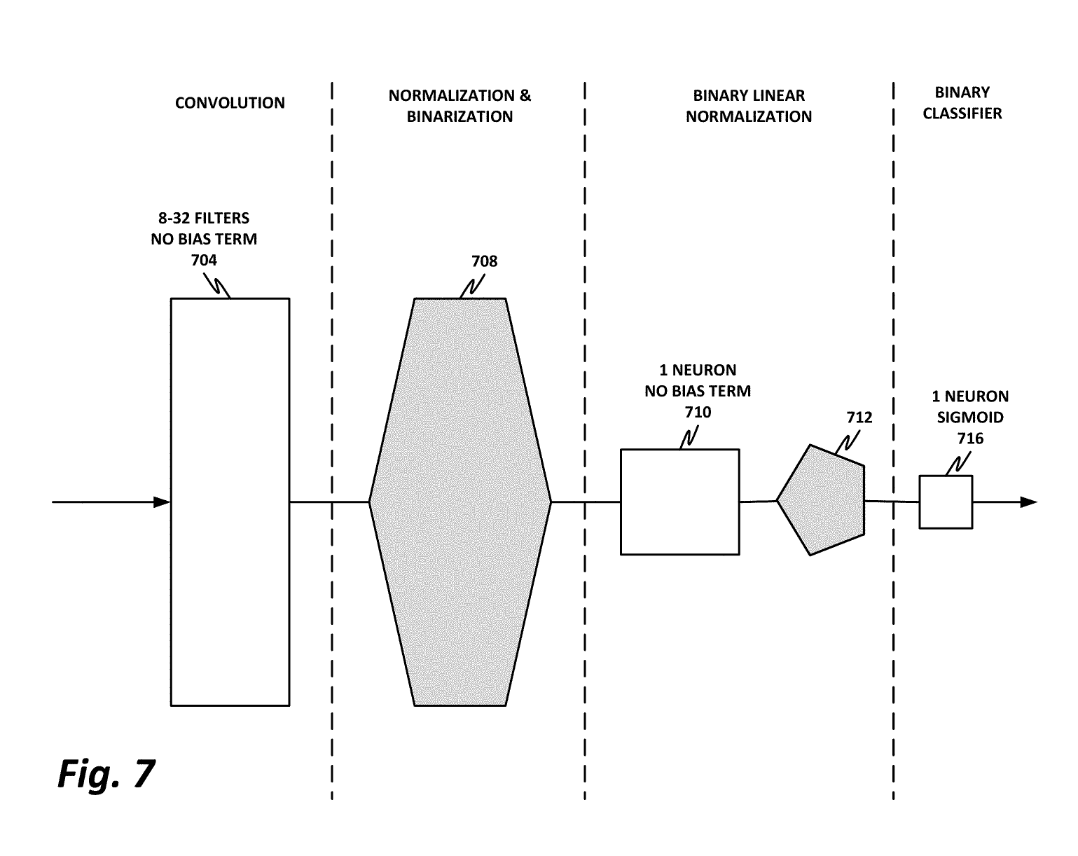

FIGS. 6 and 7 are block diagrams of CNN branch predictors according to one or more examples of the present specification.

FIG. 6 illustrates a so-called full precision CNN implementation. While the full precision CNN implementation provides the highest possible prediction accuracy, in some embodiments it may not be feasible to implement a full precision CNN predictor in a real system. Thus, in FIG. 7, there is disclosed a simplified branch predictor CNN according to one or more examples of the present specification. The simplified branch predictor of FIG. 7 may have less overall precision then the full implementation of FIG. 6, but may still realize close to the same branch prediction accuracy.

The full precision CNN of FIG. 6 has a 32-bit floating-point weight, and is configured according to the layout illustrated in this figure. This includes two convolution layers 604, each with 32 filters. The first convolution layer has a filter length of 1, and the second layer has a filter length of 3.

A pooling layer then includes a pairwise max 608. The max pooling layer takes the maximum filter response over a neighboring position in the history data.

This is followed by a linear layer with 16 neurons 612, each capable of latching to a different pattern in the lower-layer filter responses.

The final layer is a binary classifier, which in this embodiment is a sigmoid classifier with a one neuron sigmoid 616. This uses network responses to compute a value between 0 and 1, with all values above 0.5 corresponding to a “taken” prediction. In this embodiment, the tan h activation functions for all neurons are used in the network, except for the classification layer.

FIG. 7 illustrates a simplified CNN branch predictor that may be more practical for implementing in certain embodiments of a processor, coprocessor, FPGA, or other special branch predictor. This embodiment features a single convolutional layer with a filter length 1 and binary weights as illustrated in block 704. This may include between 8 and 32 filters, with no bias term. Next are normalization and binarization layers with a block 708 to scale and quantize responses to one bit.

The binary linear layer includes a single neuron with no bias term 710, followed by a normalization block 712, with results feeding directly into the binary classifier layer with a one-neuron sigmoid 716.

In the embodiment of FIG. 7, by way of nonlimiting example, the bias term in convolution and linear layers is disabled. Because input vectors are also binary, this network closely resembles an XOR net. Network weights may be trained at full precision, and quantized after training for inference.

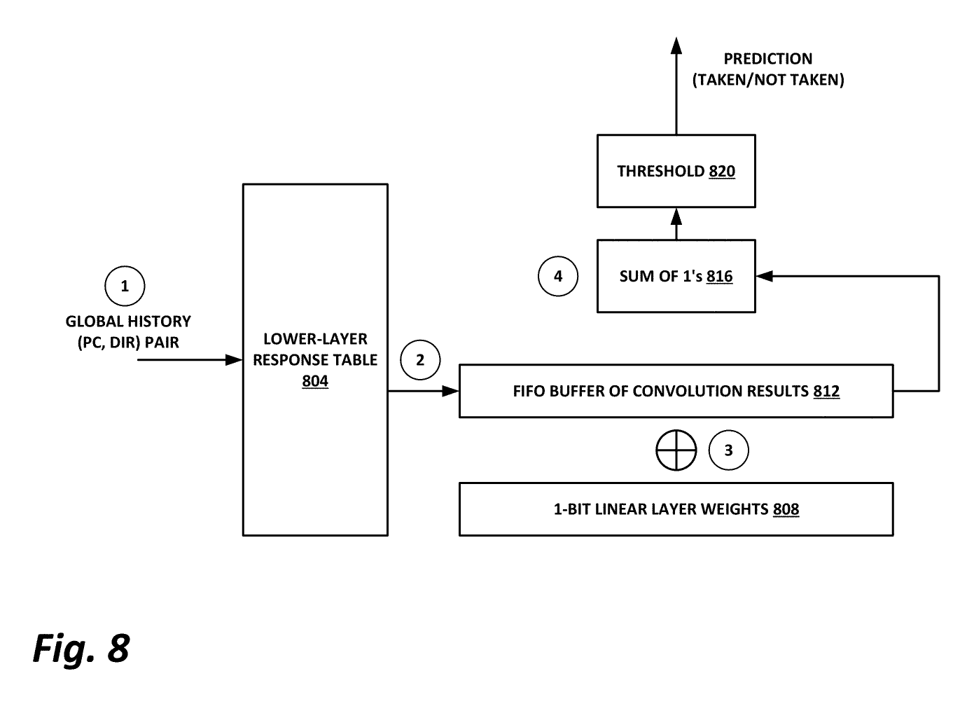

FIG. 8 is a block diagram of a special branch prediction apparatus and method according to one or more examples of the present specification.

An advantage of the special branch predictor of FIG. 8 is that once trained, its inference computation can be simplified to fit the constraints of an on-chip BPU. Note that an inner product between {−1,+1}^{N} vectors can be implemented as an XOR, popcount, shift, and subtract operations applied to corresponding {0,1}^{N} representations. Thus, this design employs, by way of nonlimiting example, three optimizations:
1. When a 1-hot vector is multiplied by a filter, the result is always the filter coefficient corresponding to nonzero value's position. Since data may be encoded by indexing from (PC, direction) values into the 1-hot input vector, the matrix representation may be substituted for table lookups on the chip. Using this method, the first layer of the network may be implemented by indexing directly from history data into a table of convolutional filter weights. Furthermore, the subsequent normalization and binarization operations produce a single bit for each possible filter weight, thus, results can be precomputed for those layers ahead of time, when populating the lookup table. For m filters, denoted wⱼ for j=1 . . . m, of length 2^{b}, and learned parameters μ1, σ1, γ1, β1 for normalization layer that transforms data according to:

$$\hat{x} = ( x - {μ}_{1} ) ( \frac{{γ}_{1}}{{σ}_{1}} ) + {β}_{1}$$

Populate a 2^{b}× m bit table T as:

$$T [ i , j ] = \{ \begin{matrix}1 , & if {w}_{j} > - \frac{{β}_{1}}{{γ}_{1}} {σ}_{1} + {μ}_{1} \\ 0 , & otherwise\end{matrix} \\ for i = 1 … b , j = 1 … m$$

The contents of this table are the first portion of the meta data that will be cached in the BPU.
b. When applying convolution of length 1, filter responses for each position in the input sequence are independent of their neighbors. Thus, this allows the branch predictor to compute the lower layer responses (the values after convolution, normalization, and binarization) well before the HTP is fetched. When a conditional instruction is executed, the corresponding lower-layer responses may be retrieved from the lookup table and pushed into a first in, first out (FIFO) buffer. The FIFO buffer contains responses for a global history of, for example, 200 branches at any given time. When the HTP is fetched and a prediction is needed, the buffer contents can be directly fed into higher network layers to compute a prediction.
c. To generate a prediction, the branch predictor may evaluate the binary linear, normalization, and sigmoid classifier layers. Respectively, this may require an inner product between the FIFO buffer's binary contents and the binary linear layer's weights, scaling and shifting the resulting integer values by learned normalization parameters, and finally comparing the result to 0.5 to determine whether the branch will be “taken” or “not taken.” However, by folding the last shift and subtraction operations of the binary inner product into the normalization formula, and solving for the crossing point of the sigmoid threshold, the branch predictor may compute a single integer threshold to take the place of these operations. As a result, the prediction operation is reduced to the first two operations of the binary inner product: parallel XORs, a popcount, and an integer comparison. Given the learned normalization parameters, a FIFO buffer of length 200×m, and noting that the sigmoid function crosses 0.5 for an input of 0, the threshold t is computed by solving:

$$t < - \frac{1}{2} ⌊ \frac{- β 2}{γ 2} σ 2 + μ 2 - 200 * m ⌋$$

On-chip inference corresponding to a BP-CNN helper predictor is illustrated in FIG. 8. This illustrates a four-stage process of performing branch prediction.

At operation 1, data arrives including a global history with (PC, direction) pairs, at lower-layer response table 804.

At operation 2, results are pushed into a FIFO buffer 812 that will hold the results of convolutions.

At operation 3, when the HTP is fetched, the buffer contents are XORed with 1-bit binary linear layer weights 808. The number of resulting ones is then counted.

At operation 4, the sum of ones 816 is compared to a threshold 820. This comparison to the threshold results in a prediction of either the branch is taken or not taken.

Embodiments of the design of an on-chip CNN branch predictor may include storage for four components:
1. A 2^{b}×m bit table to hold filter responses.
2. A history length×m-bit FIFO buffer to hold convolution results.
3. A history length×m-bit buffer to hold the binary linear layer weights.
4. A buffer to hold the precomputed integer threshold.

As a result, storage may be driven by the size of input value mapping 2^{b}, the number of convolution filters in the network m, and the history length. For example, the storage required by a CNN with b=8, m=32, and history length 200 is 20,992 bits. When m is decreased to 24 storage is 15,744 bits. For m=12, storage is 7,872 bits.

It has further been found via analysis that HTPs often occur in distinct workload phases. This offers opportunities for reusing CNN storage over time. For example, a particular workload may have four HTPs, with only two ever executing in the same workload phase. This allows the branch predictor to half the amount of storage required on-chip.

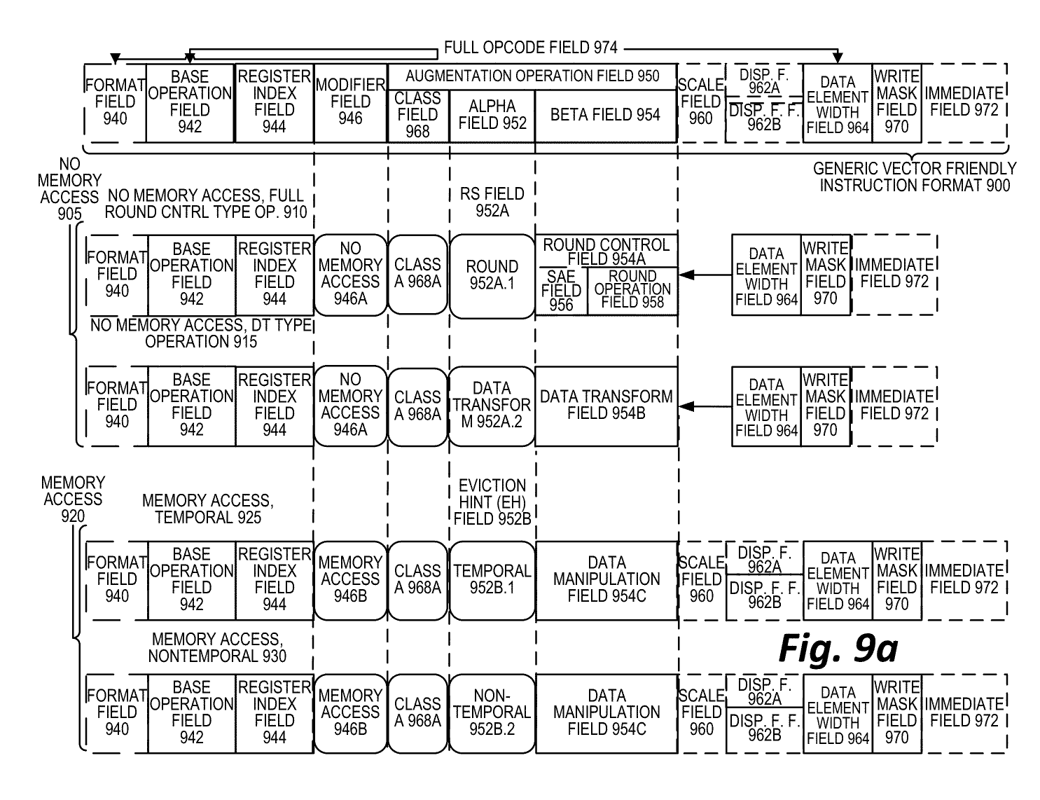

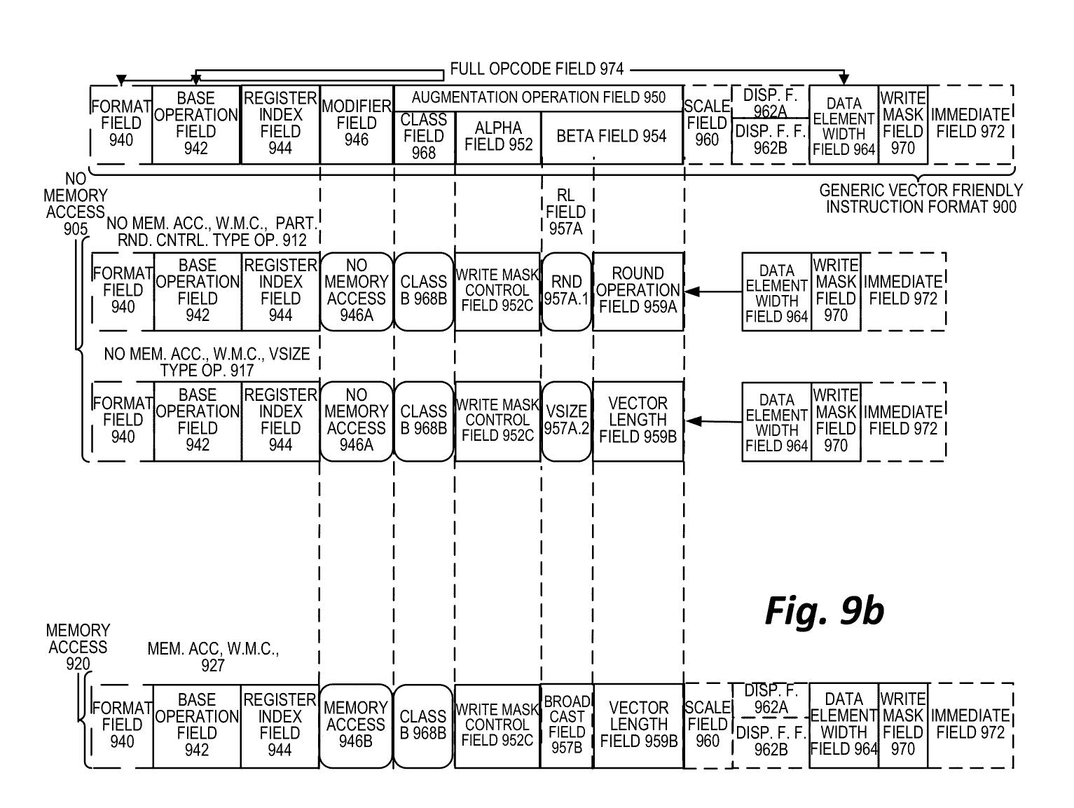

FIGS. 9a-9b are block diagrams illustrating a generic vector-friendly instruction format and instruction templates thereof according to embodiments of the specification. FIG. 9a is a block diagram illustrating a generic vector-friendly instruction format and class A instruction templates thereof according to embodiments of the specification; while FIG. 9b is a block diagram illustrating the generic vector-friendly instruction format and class B instruction templates thereof according to embodiments of the specification. Specifically, a generic vector-friendly instruction format 900 for which are defined class A and class B instruction templates, both of which include no memory access 905 instruction templates and memory access 920 instruction templates. The term generic in the context of the vector-friendly instruction format refers to the instruction format not being tied to any specific instruction set.

Embodiments of the specification will be described in which the vector-friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 1056 byte vector operands) with more, less, or different data element widths (e.g., 928 bit (16 byte) data element widths).

The class A instruction templates in FIG. 1a include: 1) within the no memory access 905 instruction templates there is shown a no memory access, full round control type operation 910 instruction template and a no memory access, data transform type operation 915 instruction template; and 2) within the memory access 920 instruction templates there is shown a memory access, temporal 925 instruction template and a memory access, nontemporal 930 instruction template. The class B instruction templates in FIG. 1b include: 1) within the no memory access 905 instruction templates there is shown a no memory access, write mask control, partial round control type operation 912 instruction template and a no memory access, write mask control, VSIZE type operation 917 instruction template; and 2) within the memory access 920 instruction templates there is shown a memory access, write mask control 927 instruction template.

The generic vector-friendly instruction format 900 includes the following fields listed below in the order illustrated in FIGS. 1a-1b.

Format field 940—a specific value (an instruction format identifier value) in this field uniquely identifies the vector-friendly instruction format, and thus occurrences of instructions in the vector-friendly instruction format in instruction streams. As such, this field is optional in the sense that it is not needed for an instruction set that has only the generic vector-friendly instruction format.

Base operation field 942—its content distinguishes different base operations.

Register index field 944—its content, directly or through address generation, specifies the locations of the source and destination operands, be they in registers or in memory. These include a sufficient number of bits to select N registers from a P×Q (e.g. 32×1312, 16×928, 32×9024, 64×9024) register file. While in one embodiment N may be up to three sources and one destination register, alternative embodiments may support more or fewer sources and destination registers (e.g., may support up to two sources where one of these sources also acts as the destination, may support up to three sources where one of these sources also acts as the destination, or may support up to two sources and one destination).

Modifier field 946—its content distinguishes occurrences of instructions in the generic vector instruction format that specify memory access from those that do not; that is, between no memory access 905 instruction templates and memory access 920 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, fewer, or different ways to perform memory address calculations.

Augmentation operation field 950—its content distinguishes which one of a variety of different operations to be performed in addition to the base operation. This field is context specific. In one embodiment of the specification, this field is divided into a class field 968, an alpha field 952, and a beta field 954. The augmentation operation field 950 allows common groups of operations to be performed in a single instruction rather than 2, 3, or 4 instructions.

Scale field 960—its content allows for the scaling of the index field's content for memory address generation (e.g., for address generation that uses 2^{scale}*index+base).

Displacement Field 962A—its content is used as part of memory address generation (e.g., for address generation that uses 2^{scale}*index+base+displacement).

Displacement Factor Field 962B (note that the juxtaposition of displacement field 962A directly over displacement factor field 962B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operand's total size (N) in order to generate the final displacement to be used in calculating an effective address. The value of N is determined by the processor hardware at runtime based on the full opcode field 974 (described later herein) and the data manipulation field 954C. The displacement field 962A and the displacement factor field 962B are optional in the sense that they are not used for the no memory access 905 instruction templates and/or different embodiments may implement only one or none of the two.

Data element width field 964—its content distinguishes which one of a number of data element widths is to be used (in some embodiments, for all instructions; in other embodiments, for only some of the instructions). This field is optional in the sense that it is not needed if only one data element width is supported and/or data element widths are supported using some aspect of the opcodes.

Write mask field 970—its content controls, on a per data element position basis, whether that data element position in the destination vector operand reflects the result of the base operation and augmentation operation. Class A instruction templates support merging-write masking, while class B instruction templates support both merging and zeroing-write masking. When merging, vector masks allow any set of elements in the destination to be protected from updates during the execution of any operation (specified by the base operation and the augmentation operation)—in one embodiment, preserving the old value of each element of the destination where the corresponding mask bit has a 0. In contrast, when zeroing vector masks allow any set of elements in the destination to be zeroed during the execution of any operation (specified by the base operation and the augmentation operation), in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 970 allows for partial vector operations, including loads, stores, arithmetic, logical, etc. While embodiments of the specification are described in which the write mask field's 970 content selects one of a number of write mask registers that contains the write mask to be used (and thus the write mask field's 970 content indirectly identifies that masking to be performed), alternative embodiments instead or additionally allow the mask write field's 970 content to directly specify the masking to be performed.

Immediate field 972—its content allows for the specification of an immediate. This field is optional in the sense that is it not present in an implementation of the generic vector-friendly format that does not support immediate and it is not present in instructions that do not use an immediate.

Class field 968—its content distinguishes between different classes of instructions. With reference to FIGS. 1a-1b, the contents of this field select between class A and class B instructions. In FIGS. 1a-1b, rounded corner squares are used to indicate a specific value is present in a field (e.g., class A 968A and class B 968B for the class field 968 respectively in FIGS. 1a-1b).

Instruction Templates of Class A

In the case of the non-memory access 905 instruction templates of class A, the alpha field 952 is interpreted as an RS field 952A, whose content distinguishes which one of the different augmentation operation types are to be performed (e.g., round 952A.1 and data transform 952A.2 are respectively specified for the no memory access, round type operation 910 and the no memory access, data transform type operation 915 instruction templates), while the beta field 954 distinguishes which of the operations of the specified type is to be performed. In the no memory access 905 instruction templates, the scale field 960, the displacement field 962A, and the displacement scale filed 962B are not present.

No-Memory Access Instruction Templates—Full Round Control Type Operation

In the no memory access full round control type operation 910 instruction template, the beta field 954 is interpreted as a round control field 954A, whose content provides static rounding. While in the described embodiments of the specification the round control field 954A includes a suppress all floating point exceptions (SAE) field 956 and a round operation control field 958, alternative embodiments may encode both these concepts into the same field or only have one or the other of these concepts/fields (e.g., may have only the round operation control field 958).

SAE field 956—its content distinguishes whether or not to disable the exception event reporting; when the SAE field's 956 content indicates suppression is enabled, a given instruction does not report any kind of floating-point exception flag and does not raise any floating point exception handler.

Round operation control field 958—its content distinguishes which one of a group of rounding operations to perform (e.g., round-up, round-down, round-towards-zero and round-to-nearest). Thus, the round operation control field 958 allows for the changing of the rounding mode on a per instruction basis. In one embodiment of the specification where a processor includes a control register for specifying rounding modes, the round operation control field's 950 content overrides that register value.

No Memory Access Instruction Templates—Data Transform Type Operation

In the no memory access data transform type operation 915 instruction template, the beta field 954 is interpreted as a data transform field 954B, whose content distinguishes which one of a number of data transforms is to be performed (e.g., no data transform, swizzle, broadcast).

In the case of a memory access 920 instruction template of class A, the alpha field 952 is interpreted as an eviction hint field 952B, whose content distinguishes which one of the eviction hints is to be used (in FIG. 1a, temporal 952B.1 and nontemporal 952B.2 are respectively specified for the memory access, temporal 925 instruction template and the memory access, nontemporal 930 instruction template), while the beta field 954 is interpreted as a data manipulation field 954C, whose content distinguishes which one of a number of data manipulation operations (also known as primitives) is to be performed (e.g., no manipulation; broadcast; up conversion of a source; and down conversion of a destination). The memory access 920 instruction templates include the scale field 960, and optionally the displacement field 962A or the displacement scale field 962B.

Vector memory instructions perform vector loads from and vector stores to memory, with conversion support. As with regular vector instructions, vector memory instructions transfer data from/to memory in a data element-wise fashion, with the elements that are actually transferred as dictated by the contents of the vector mask that is selected as the write mask.

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Nontemporal

Nontemporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 952 is interpreted as a write mask control (Z) field 952C, whose content distinguishes whether the write masking controlled by the write mask field 970 should be a merging or a zeroing.

In the case of the non-memory access 905 instruction templates of class B, part of the beta field 954 is interpreted as an RL field 957A, whose content distinguishes which one of the different augmentation operation types are to be performed (e.g., round 957A.1 and vector length (VSIZE) 957A.2 are respectively specified for the no memory access, write mask control, partial round control type operation 912 instruction template and the no memory access, write mask control, VSIZE type operation 917 instruction template), while the rest of the beta field 954 distinguishes which of the operations of the specified type is to be performed. In the no memory access 905 instruction templates, the scale field 960, the displacement field 962A, and the displacement scale field 962B are not present.

In the no memory access, write mask control, partial round control type operation 910 instruction template, the rest of the beta field 954 is interpreted as a round operation field 959A and exception event reporting is disabled (a given instruction does not report any kind of floating-point exception flag and does not raise any floating point exception handler).

Round operation control field 959A—just as round operation control field 958, its content distinguishes which one of a group of rounding operations to perform (e.g., round-up, round-down, round-towards-zero and round-to-nearest). Thus, the round operation control field 959A allows for the changing of the rounding mode on a per instruction basis. In one embodiment of the specification where a processor includes a control register for specifying rounding modes, the round operation control field's 950 content overrides that register value.

In the no memory access, write mask control, VSIZE type operation 917 instruction template, the rest of the beta field 954 is interpreted as a vector length field 959B, whose content distinguishes which one of a number of data vector lengths is to be performed on (e.g., 928, 1056, or 1312 byte).

In the case of a memory access 920 instruction template of class B, part of the beta field 954 is interpreted as a broadcast field 957B, whose content distinguishes whether or not the broadcast type data manipulation operation is to be performed, while the rest of the beta field 954 is interpreted by the vector length field 959B. The memory access 920 instruction templates include the scale field 960, and optionally the displacement field 962A or the displacement scale field 962B.

With regard to the generic vector-friendly instruction format 900, a full opcode field 974 is shown including the format field 940, the base operation field 942, and the data element width field 964. While one embodiment is shown where the full opcode field 974 includes all of these fields, the full opcode field 974 includes less than all of these fields in embodiments that do not support all of them. The full opcode field 974 provides the operation code (opcode).

The augmentation operation field 950, the data element width field 964, and the write mask field 970 allow these features to be specified on a per instruction basis in the generic vector-friendly instruction format.

The combination of write mask field and data element width field create typed instructions in that they allow the mask to be applied based on different data element widths.

The various instruction templates found within class A and class B are beneficial in different situations. In some embodiments of the specification, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the specification). Also, a single processor may include multiple cores, all of which support the same class or in which different cores support different classes. For instance, in a processor with separate graphics and general purpose cores, one of the graphics cores intended primarily for graphics and/or scientific computing may support only class A, while one or more of the general purpose cores may be high performance general purpose cores with out-of-order execution and register renaming intended for general-purpose computing that supports only class B. Another processor that does not have a separate graphics core may include one more general purpose in-order or out-of-order cores that support both class A and class B. Of course, features from one class may also be implemented in the other class in different embodiments of the specification. Programs written in a high level language would be put (e.g., just in time compiled or statically compiled) into an variety of different executable forms, including: 1) a form having only instructions of the class or classes supported by the target processor for execution; or 2) a form having alternative routines written using different combinations of the instructions of all classes and having control flow code that selects the routines to execute based on the instructions supported by the processor which is currently executing the code.

Example Specific Vector-Friendly Instruction Format

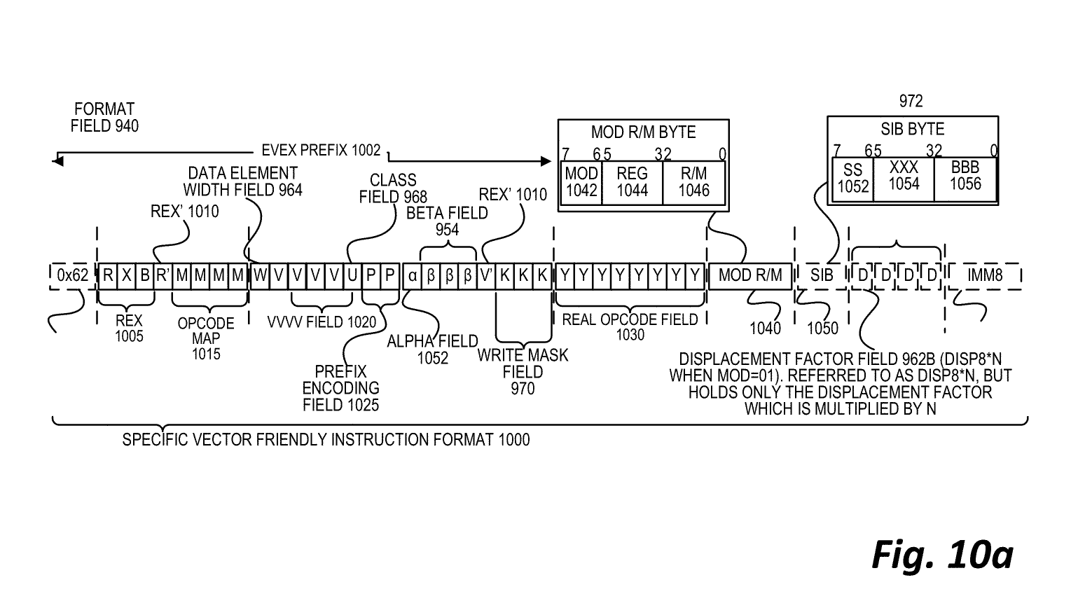

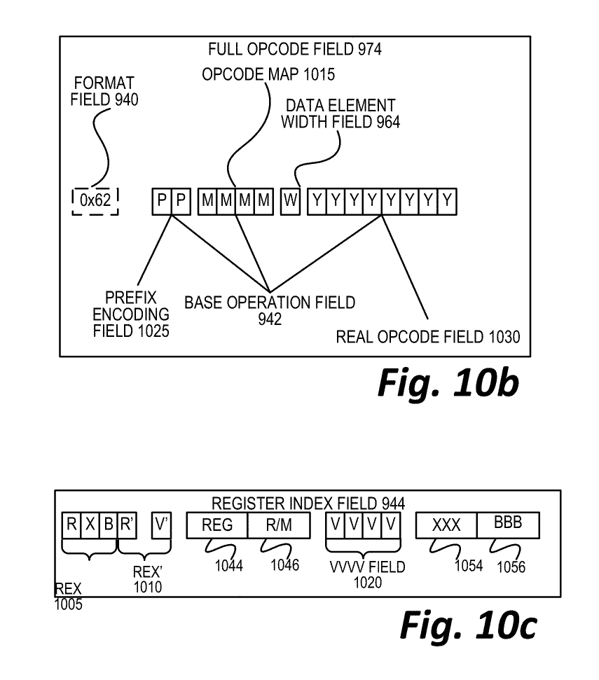

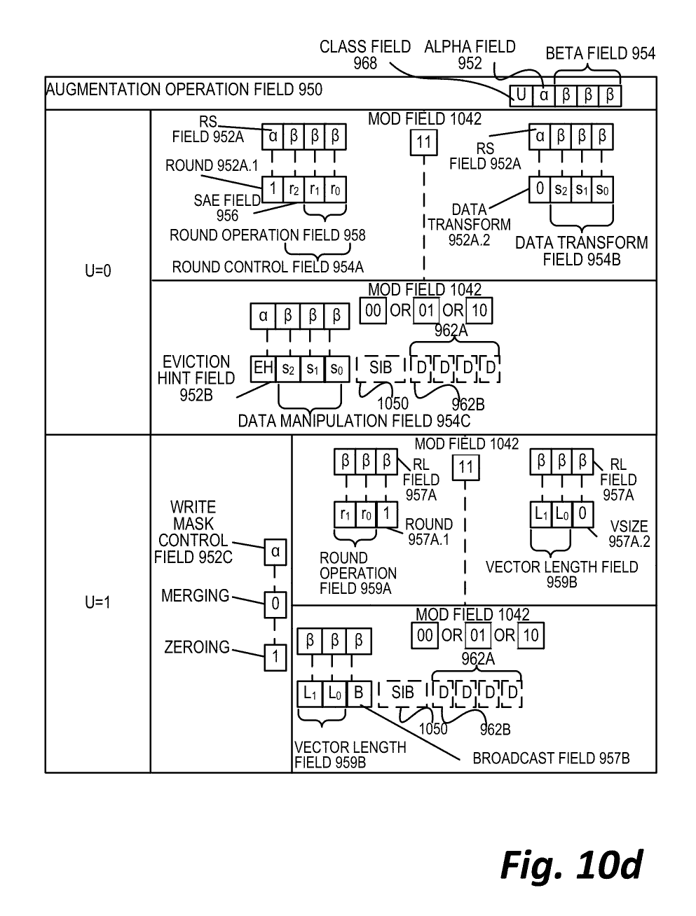

FIGS. 10a-10d are block diagrams illustrating an example specific vector-friendly instruction format according to one or more examples of the present specification. FIG. 10a shows a specific vector-friendly instruction format 1000 that is specific in the sense that it specifies the location, size, interpretation, and order of the fields, as well as values for some of those fields. The specific vector-friendly instruction format 1000 may be used to extend the x86 instruction set, and thus some of the fields are similar or the same as those used in the existing x86 instruction set and extension thereof (e.g., AVX). This format remains consistent with the prefix encoding field, real opcode byte field, MOD RIM field, SIB field, displacement field, and immediate fields of the existing x86 instruction set with extensions. The fields from FIGS. 9a and 9b into which the fields from FIGS. 10a-10d map are illustrated.

It should be understood that, although embodiments of the specification are described with reference to the specific vector-friendly instruction format 1000 in the context of the generic vector-friendly instruction format 900 for illustrative purposes, the present specification is not limited to the specific vector-friendly instruction format 1000 except where claimed. For example, the generic vector-friendly instruction format 900 contemplates a variety of possible sizes for the various fields, while the specific vector-friendly instruction format 1000 is shown as having fields of specific sizes. By way of particular example, while the data element width field 964 is illustrated as a one bit field in the specific vector-friendly instruction format 1000, the present specification is not so limited (that is, the generic vector-friendly instruction format 900 contemplates other sizes of the data element width field 964).

The generic vector-friendly instruction format 900 includes the following fields listed below in the order illustrated in FIG. 10a.

EVEX Prefix (Bytes 0-3) 1002—is encoded in a four-byte form.

Format Field 940 (EVEX Byte 0, bits [7:0])—the first byte (EVEX Byte 0) is the format field 940 and it contains 0x62 (the unique value used for distinguishing the vector-friendly instruction format in one embodiment).

The second through fourth bytes (EVEX Bytes 1-3) include a number of bit fields providing specific capability.

REX field 1005 (EVEX Byte 1, bits [7-5])—consists of an EVEX.R bit field (EVEX Byte 1, bit [7]—R), EVEX.X bit field (EVEX byte 1, bit [6]—X), and 957BEX byte 1, bit[5]—B). The EVEX.R, EVEX.X, and EVEX.B bit fields provide the same functionality as the corresponding VEX bit fields, and are encoded using 1s complement form, i.e. ZMM0 is encoded as 9111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 910—this is the first part of the REX′ field 910 and is the EVEX.R′ bit field (EVEX Byte 1, bit [4]—R′) that is used to encode either the upper 16 or lower 16 of the extended 32 register set. In one embodiment, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; other embodiments do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1015 (EVEX byte 1, bits [3:0]—mmmm)—its content encodes an implied leading opcode byte (0F, 0F 38, or 0F 3).

Data element width field 964 (EVEX byte 2, bit [7]—W)—is represented by the notation EVEX.W. EVEX.W is used to define the granularity (size) of the datatype (either 32-bit data elements or 64-bit data elements).

EVEX.vvvv 1020 (EVEX Byte 2, bits [6:3]—vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 9111b. Thus, EVEX.vvvv field 1020 encodes the 4 low-order bits of the first source register specifier stored in inverted (1s complement) form. Depending on the instruction, an extra different EVEX bit field is used to extend the specifier size to 32 registers.

EVEX.U 968 Class field (EVEX byte 2, bit [2]—U)—if EVEX.U=0, it indicates class A or EVEX.U0; if EVEX.0=1, it indicates class B or EVEX.U1.

Prefix encoding field 1025 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use an SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 952 (EVEX byte 3, bit [7]—EH; also known as EVEX.eh, EVEX.rs, EVEX.rl, EVEX.write mask control, and EVEX.n; also illustrated with α)—as previously described, this field is context specific.

Beta field 954 (EVEX byte 3, bits [6:4]—SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 910—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 970 (EVEX byte 3, bits [2:0]—kkk)—its content specifies the index of a register in the write mask registers as previously described. In one embodiment, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1030 (Byte 4) is also known as the opcode byte. Part of the opcode is specified in this field.

MOD R/M Field 1040 (Byte 5) includes MOD field 1042, Reg field 1044, and R/M field 1046. As previously described, the MOD field's 1042 content distinguishes between memory access and non-memory access operations. The role of Reg field 1044 can be summarized to two situations: encoding either the destination register operand or a source register operand, or be treated as an opcode extension and not used to encode any instruction operand. The role of R/M field 1046 may include the following: encoding the instruction operand that references a memory address, or encoding either the destination register operand or a source register operand.

Scale, Index, Base (SIB) Byte (Byte 6)—as previously described, the scale field's 950 content is used for memory address generation. SIB.xxx 1054 and SIB.bbb 1056—the contents of these fields have been previously referred to with regard to the register indexes Xxxx and Bbbb.

Displacement field 962A (Bytes 7-10)—when MOD field 1042 contains 10, bytes 7-10 are the displacement field 962A, and it works the same as the legacy 32-bit displacement (disp32) and works at byte granularity.

Displacement factor field 962B (Byte 7)—when MOD field 1042 contains 01, byte 7 is the displacement factor field 962B. The location of this field is the same as that of the legacy x86 instruction set 8-bit displacement (disp8), which works at byte granularity. Since disp8 is sign extended, it can only address between 928 and 927-byte offsets; in terms of 64 byte cache lines, disp8 uses 8 bits that can be set to only four really useful values −928, −64, 0, and 64; since a greater range is often needed, disp32 is used; however, disp32 requires 4 bytes.

In contrast to disp8 and disp32, the displacement factor field 962B is a reinterpretation of disp8; when using displacement factor field 962B, the actual displacement is determined by the content of the displacement factor field multiplied by the size of the memory operand access (N).

This type of displacement is referred to as disp8*N. This reduces the average instruction length (a single byte used for the displacement but with a much greater range). Such compressed displacement is based on the assumption that the effective displacement is a multiple of the granularity of the memory access, and hence, the redundant low-order bits of the address offset do not need to be encoded. In other words, the displacement factor field 962B substitutes the legacy x86 instruction set 8-bit displacement.

Thus, the displacement factor field 962B is encoded the same way as an x86 instruction set 8-bit displacement (so no changes in the ModRM/SIB encoding rules) with the only exception that disp8 is overloaded to disp8*N.

In other words, there are no changes in the encoding rules or encoding lengths but only in the interpretation of the displacement value by hardware (which needs to scale the displacement by the size of the memory operand to obtain a byte-wise address offset).

Immediate field 972 operates as previously described.

Full Opcode Field

FIG. 10b is a block diagram illustrating the fields of the specific vector-friendly instruction format 1000 that make up the full opcode field 974 according to one embodiment. Specifically, the full opcode field 974 includes the format field 940, the base operation field 942, and the data element width (W) field 964. The base operation field 942 includes the prefix encoding field 1025, the opcode map field 1015, and the real opcode field 1030.

Register Index Field

FIG. 10c is a block diagram illustrating the fields of the specific vector-friendly instruction format 1000 that make up the register index field 944 according to one embodiment. Specifically, the register index field 944 includes the REX field 1005, the REX′ field 1010, the MODR/M.reg field 1044, the MODR/M.r/m field 1046, the VVVV field 1020, xxx field 1054, and the bbb field 1056.

Augmentation Operation Field

FIG. 10d is a block diagram illustrating the fields of the specific vector-friendly instruction format 1000 that make up the augmentation operation field 950 according to one embodiment. When the class (U) field 968 contains 0, it signifies EVEX.U0 (class A 968A); when it contains 1, it signifies EVEX.U1 (class B 968B). When U=0 and the MOD field 1042 contains 11 (signifying a no memory access operation), the alpha field 952 (EVEX byte 3, bit [7]—EH) is interpreted as the rs field 952A. When the rs field 952A contains a 1 (round 952A.1), the beta field 954 (EVEX byte 3, bits [6:4]—SSS) is interpreted as the round control field 954A. The round control field 954A includes a one bit SAE field 956 and a two bit round operation field 958. When the rs field 952A contains a 0 (data transform 952A.2), the beta field 954 (EVEX byte 3, bits [6:4]—SSS) is interpreted as a three bit data transform field 954B. When U=0 and the MOD field 1042 contains 00, 01, or 10 (signifying a memory access operation), the alpha field 952 (EVEX byte 3, bit [7]—EH) is interpreted as the eviction hint (EH) field 952B and the beta field 954 (EVEX byte 3, bits [6:4]—SSS) is interpreted as a three bit data manipulation field 954C.

When U=1, the alpha field 952 (EVEX byte 3, bit [7]—EH) is interpreted as the write mask control (Z) field 952C. When U=1 and the MOD field 1042 contains 11 (signifying a no memory access operation), part of the beta field 954 (EVEX byte 3, bit [4]—S₀) is interpreted as the RL field 957A; when it contains a 1 (round 957A.1) the rest of the beta field 954 (EVEX byte 3, bit [6-5]—S₂₋₁) is interpreted as the round operation field 959A, while when the RL field 957A contains a 0 (VSIZE 957.A2) the rest of the beta field 954 (EVEX byte 3, bit [6-5]—S₂₋₁) is interpreted as the vector length field 959B (EVEX byte 3, bit [6-5]—L₁₋₀). When U=1 and the MOD field 1042 contains 00, 01, or 10 (signifying a memory access operation), the beta field 954 (EVEX byte 3, bits [6:4]—SSS) is interpreted as the vector length field 959B (EVEX byte 3, bit [6-5]—L₁₋₀) and the broadcast field 957B (EVEX byte 3, bit [4]—B).

Example Register Architecture

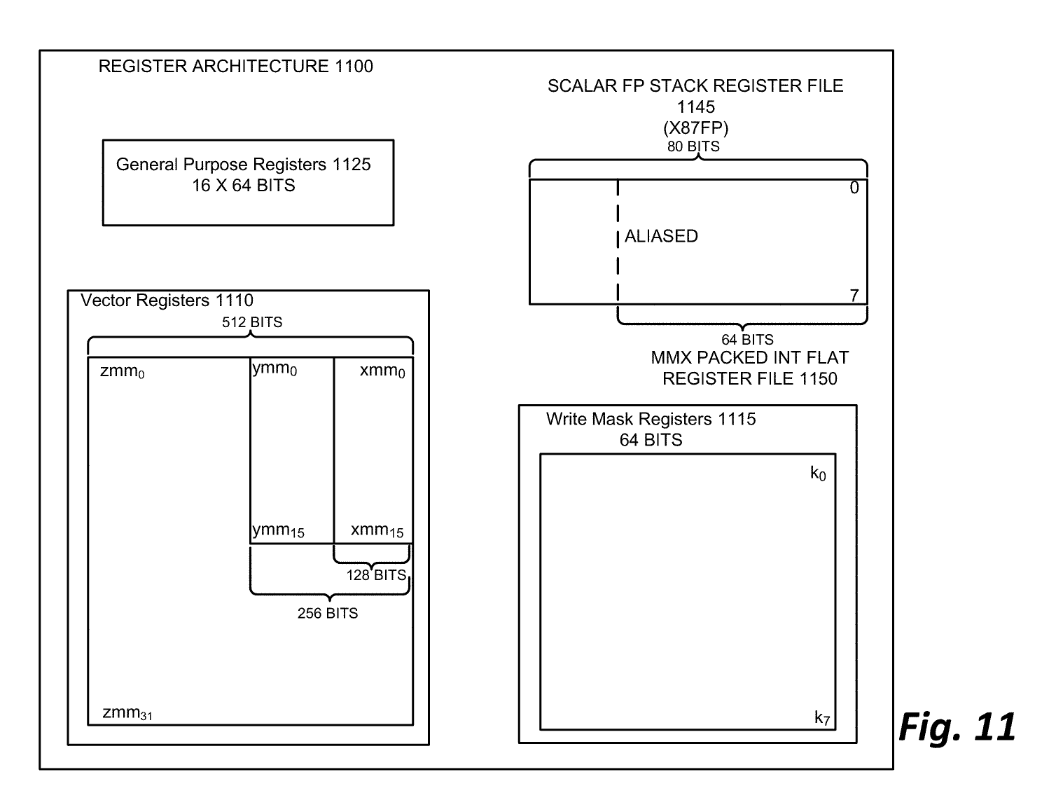

FIG. 11 is a block diagram of a register architecture 1100 according to one embodiment. In the embodiment illustrated, there are 32 vector registers 1110 that are 512 bits wide; these registers are referenced as zmm0 through zmm31.

The lower order 256 bits of the lower 16 zmm registers are overlaid on registers ymm0-16. The lower order 128 bits of the lower 16 zmm registers (the lower order 128 bits of the ymm registers) are overlaid on registers xmm0-15.

The specific vector-friendly instruction format 200 operates on these overlaid register files as illustrated in the below tables.

| Adjustable Vector | | | |
|---|---|---|---|
| Length | Class | Operations | Registers |
| Instruction | A | 910, 915, | zmm registers (the |
| Templates that do | (FIG. | 925, 930 | vector length is 64 |
| not include the | 1A; U = 0) | | byte) |
| vector length field | B | 912 | zmm registers (the |
| 959B | (FIG. | | vector length is 64 |
| | 1B; U = 1) | | byte) |
| Instruction | B | 917, 927 | zmm, ymm, or xmm |
| templates that do | (FIG. | | registers (the vector |
| include the vector | 1B; U = 1) | | length is 64 byte, 32 |
| length field 959B | | | byte, or 16 byte) |
| | | | depending on the vector |
| | | | length field 959B |

In other words, the vector length field 959B selects between a maximum length and one or more other shorter lengths, where each such shorter length is half the length of the preceding length; and instruction templates without the vector length field 959B operate on the maximum vector length. Further, in one embodiment, the class B instruction templates of the specific vector-friendly instruction format 1000 operate on packed or scalar single/double-precision floating point data and packed or scalar integer data. Scalar operations are operations performed on the lowest order data element position in a zmm/ymm/xmm register; the higher order data element positions are either left the same as they were prior to the instruction or zeroed depending on the embodiment.

Write mask registers 1115—in the embodiment illustrated, there are 8 write mask registers (k0 through k7), each 64 bits in size. In an alternate embodiment, the write mask registers 1115 are 16 bits in size. As previously described, in one embodiment, the vector mask register k0 cannot be used as a write mask; when the encoding that would normally indicate k0 is used for a write mask, it selects a hardwired write mask of 0xFFFF, effectively disabling write masking for that instruction.

General-purpose registers 1125—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1145, on which is aliased the MMX packed integer flat register file 1150—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Other embodiments may use wider or narrower registers. Additionally, other embodiments may use more, less, or different register files and registers.

Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific throughput. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Example core architectures are described next, followed by descriptions of example processors and computer architectures.

Example Core Architectures

In-Order and Out-of-Order Core Block Diagram

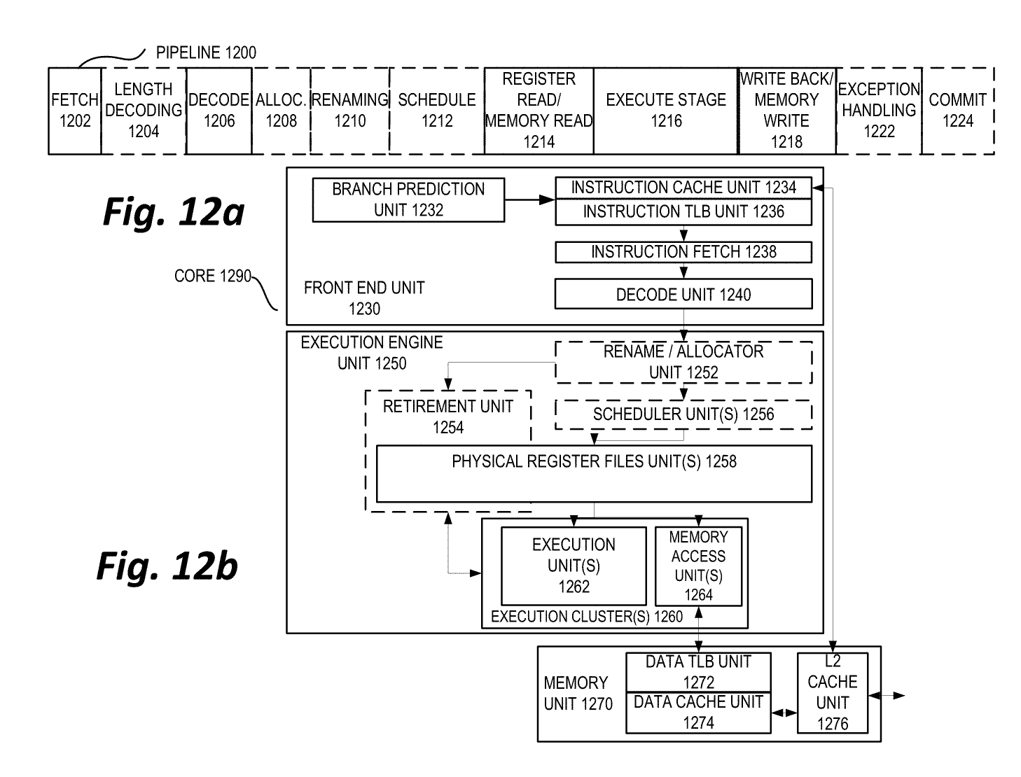

FIG. 12a is a block diagram illustrating both an example in-order pipeline and an example register renaming, out-of-order issue/execution pipeline. FIG. 12b is a block diagram illustrating both an embodiment of an in-order architecture core and an example register renaming, out-of-order issue/execution architecture core to be included in a processor. The solid lined boxes in FIGS. 12a-12b illustrate the in-order pipeline and in-order core, while the optional addition of the dashed, lined boxes illustrates the register renaming, out-of-order issue/execution pipeline and core. Given that the in-order aspect is a subset of the out-of-order aspect, the out-of-order aspect will be described.

In FIG. 12a, a processor pipeline 1200 includes a fetch stage 1202, a length decode stage 1204, a decode stage 1206, an allocation stage 1208, a renaming stage 1210, a scheduling (also known as a dispatch or issue) stage 1212, a register read/memory read stage 1214, an execute stage 1216, a write back/memory write stage 1218, an exception handling stage 1222, and a commit stage 1224.

FIG. 12b shows processor core 1290 including a front end unit 1230 coupled to an execution engine unit 1250, and both are coupled to a memory unit 1270. The core 1290 may be a reduced instruction set computing (RISC) core, a complex instruction set computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front end unit 1230 includes a branch prediction unit 1232 coupled to an instruction cache unit 1234, which is coupled to an instruction translation lookaside buffer (TLB) 1236, which is coupled to an instruction fetch unit 1238, which is coupled to a decode unit 1240. The decode unit 1240 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1240 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1290 includes a microcode ROM or other medium that stores microcode for certain macroinstructions (e.g., in decode unit 1240 or otherwise within the front end unit 1230). The decode unit 1240 is coupled to a rename/allocator unit 1252 in the execution engine unit 1250.

The execution engine unit 1250 includes the rename/allocator unit 1252 coupled to a retirement unit 1254 and a set of one or more scheduler unit(s) 1256. The scheduler unit(s) 1256 represents any number of different schedulers, including reservation stations, central instruction window, etc. The scheduler unit(s) 1256 is coupled to the physical register file(s) unit(s) 1258. Each of the physical register file(s) units 1258 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1258 comprises a vector registers unit, a write mask registers unit, and a scalar registers unit. These register units may provide architectural vector registers, vector mask registers, and general purpose registers. The physical register file(s) unit(s) 1258 is overlapped by the retirement unit 1254 to illustrate various ways in which register renaming and out-of-order execution may be implemented (e.g., using a reorder buffer(s) and a retirement register file(s); using a future file(s), a history buffer(s), and a retirement register file(s); using register maps and a pool of registers; etc.). The retirement unit 1254 and the physical register file(s) unit(s) 1258 are coupled to the execution cluster(s) 1260. The execution cluster(s) 1260 includes a set of one or more execution units 1262 and a set of one or more memory access units 1264. The execution units 1262 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1256, physical register file(s) unit(s) 1258, and execution cluster(s) 1260 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1264). It should also be understood that where separate pipelines are used, one or more of these pipelines may be out-of-order issue/execution and the rest in-order.

The set of memory access units 1264 is coupled to the memory unit 1270, which includes a data TLB unit 1272 coupled to a data cache unit 1274 coupled to a level 2 (L2) cache unit 1276. In one embodiment, the memory access units 1264 may include a load unit, a store address unit, and a store data unit, each of which is coupled to the data TLB unit 1272 in the memory unit 1270. The instruction cache unit 1234 is further coupled to a level 2 (L2) cache unit 1276 in the memory unit 1270. The L2 cache unit 1276 is coupled to one or more other levels of cache and eventually to a main memory.

By way of example, the register renaming, out-of-order issue/execution core architecture may implement the pipeline 1200 as follows: 1) the instruction fetch 1238 performs the fetch and length decoding stages 1202 and 1204; 2) the decode unit 1240 performs the decode stage 1206; 3) the rename/allocator unit 1252 performs the allocation stage 1208 and renaming stage 1210; 4) the scheduler unit(s) 1256 performs the schedule stage 1212; 5) the physical register file(s) unit(s) 1258 and the memory unit 1270 perform the register read/memory read stage 1214; the execution cluster 1260 performs the execute stage 1216; 6) the memory unit 1270 and the physical register file(s) unit(s) 1258 perform the write back/memory write stage 1218; 7) various units may be involved in the exception handling stage 1222; and 8) the retirement unit 1254 and the physical register file(s) unit(s) 1258 perform the commit stage 1224.

The core 1290 may support one or more instruction sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1290 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1234/1274 and a shared L2 cache unit 1276, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Example in-Order Core Architecture

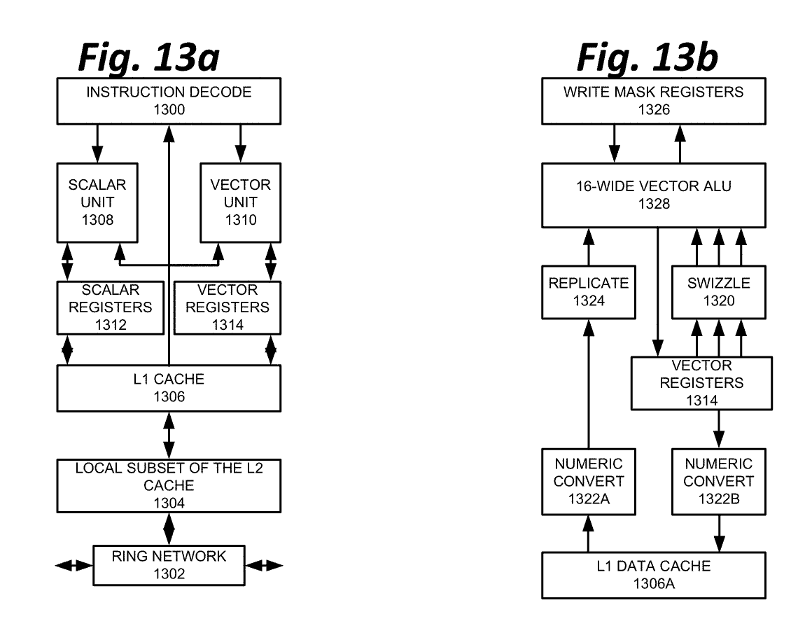

FIGS. 13a-13b illustrate a block diagram of a more specific example in-order core architecture, which core would be one of several logic blocks (including other cores of the same type and/or different types) in a chip. The logic blocks communicate through a high-bandwidth interconnect network (e.g., a ring network) with some fixed function logic, memory IO interfaces, and other necessary IO logic, depending on the application.

FIG. 13a is a block diagram of a single processor core, along with its connection to the on-die interconnect network 1302 and with its local subset of the Level 2 (L2) cache 1304, according to one or more embodiments. In one embodiment, an instruction decoder 1300 supports the x86 instruction set with a packed data instruction set extension. An L1 cache 1306 allows low-latency accesses to cache memory into the scalar and vector units. While in one embodiment (to simplify the design), a scalar unit 1308 and a vector unit 1310 use separate register sets (respectively, scalar registers 1312 and vector registers 1314) and data transferred between them is written to memory and then read back in from a level 1 (L1) cache 1306, other embodiments may use a different approach (e.g., use a single register set or include a communication path that allows data to be transferred between the two register files without being written and read back).

The local subset of the L2 cache 1304 is part of a global L2 cache that is divided into separate local subsets, one per processor core. Each processor core has a direct access path to its own local subset of the L2 cache 1304. Data read by a processor core is stored in its L2 cache subset 1304 and can be accessed quickly, in parallel with other processor cores accessing their own local L2 cache subsets. Data written by a processor core is stored in its own L2 cache subset 1304 and is flushed from other subsets, if necessary. The ring network ensures coherency for shared data. The ring network is bi-directional to allow agents such as processor cores, L2 caches and other logic blocks to communicate with each other within the chip. Each ring data-path is 9012-bits wide per direction.

FIG. 13b is an expanded view of part of the processor core in FIG. 13a according to embodiments of the specification. FIG. 13b includes an L1 data cache 1306A, part of the L1 cache 1304, as well as more detail regarding the vector unit 1310 and the vector registers 1314. Specifically, the vector unit 1310 is a 16-wide vector processing unit (VPU) (see the 16-wide ALU 1328), which executes one or more of integer, single-precision float, and double-precision float instructions. The VPU supports swizzling the register inputs with swizzle unit 1320, numeric conversion with numeric convert units 1322A-B, and replication with replication unit 1324 on the memory input. Write mask registers 1326 allow predicating resulting vector writes.

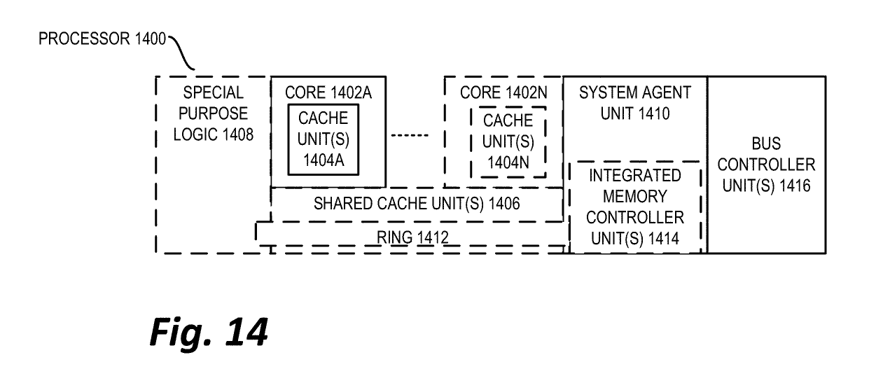

FIG. 14 is a block diagram of a processor 1400 that may have more than one core, may have an integrated memory controller, and may have integrated graphics according to embodiments of the specification. The solid lined boxes in FIG. 14 illustrate a processor 1400 with a single core 1402A, a system agent 1410, a set of one or more bus controller units 1416, while the optional addition of the dashed lined boxes illustrates an alternative processor 1400 with multiple cores 1402A-N, a set of one or more integrated memory controller unit(s) 1414 in the system agent unit 1410, and special purpose logic 1408.

Thus, different implementations of the processor 1400 may include: 1) a CPU with the special purpose logic 1408 being integrated graphics and/or scientific (throughput) logic (which may include one or more cores), and the cores 1402A-N being one or more general purpose cores (e.g., general purpose in-order cores, general purpose out-of-order cores, a combination of the two); 2) a coprocessor with the cores 1402A-N being a large number of special purpose cores intended primarily for graphics and/or scientific throughput; and 3) a coprocessor with the cores 1402A-N being a large number of general purpose in-order cores. Thus, the processor 1400 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1400 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1406, and external memory (not shown) coupled to the set of integrated memory controller units 1414. The set of shared cache units 1406 may include one or more mid-level caches, such as level 2 (L2), level 3 (L3), level 4 (L4), or other levels of cache, a last level cache (LLC), and/or combinations thereof. While in one embodiment a ring based interconnect unit 1412 interconnects the integrated graphics logic 1408, the set of shared cache units 1406, and the system agent unit 1410/integrated memory controller unit(s) 1414, alternative embodiments may use any number of well-known techniques for interconnecting such units. In one embodiment, coherency is maintained between one or more cache units 1406 and cores 1402A-N.

In some embodiments, one or more of the cores 1402A-N are capable of multi-threading. The system agent 1410 includes those components coordinating and operating cores 1402A-N. The system agent unit 1410 may include, for example, a power control unit (PCU) and a display unit. The PCU may be or include logic and components needed for regulating the power state of the cores 1402A-N and the integrated graphics logic 1408. The display unit is for driving one or more externally connected displays.

The cores 1402A-N may be homogenous or heterogeneous in terms of architecture instruction set; that is, two or more of the cores 1402A-N may be capable of executing the same instruction set, while others may be capable of executing only a subset of that instruction set or a different instruction set.

Example Computer Architectures

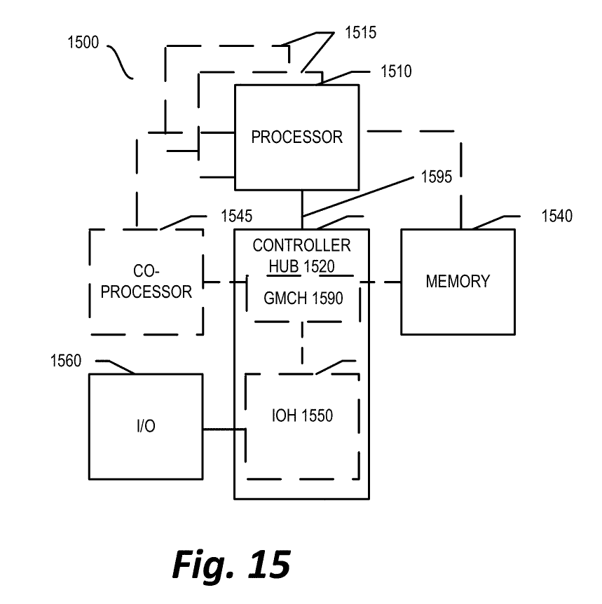

FIGS. 15-18 are block diagrams of example computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 15, shown is a block diagram of a system 1500 in accordance with one embodiment. The system 1500 may include one or more processors 1510, 1515, which are coupled to a controller hub 1520. In one embodiment the controller hub 1520 includes a graphics memory controller hub (GMCH) 1590 and an Input/Output Hub (IOH) 1550 (which may be on separate chips); the GMCH 1590 includes memory and graphics controllers to which are coupled memory 1540 and a coprocessor 1545; the IOH 1550 couples input/output (IO) devices 1560 to the GMCH 1590. Alternatively, one or both of the memory and graphics controllers are integrated within the processor (as described herein), the memory 1540 and the coprocessor 1545 are coupled directly to the processor 1510, and the controller hub 1520 in a single chip with the IOH 1550.

The optional nature of additional processors 1515 is denoted in FIG. 15 with broken lines. Each processor 1510, 1515 may include one or more of the processing cores described herein and may be some version of the processor 1400.

The memory 1540 may be, for example, dynamic random access memory (DRAM), phase change memory (PCM), or a combination of the two. For at least one embodiment, the controller hub 1520 communicates with the processor(s) 1510, 1515 via a multidrop bus, such as a frontside bus (FSB), point-to-point interface such as Ultra Path Interconnect (UPI), or similar connection 1595.

In one embodiment, the coprocessor 1545 is a special-purpose processor, such as, for example, a high-throughput MIC processor, a network or communication processor, compression engine, graphics processor, GPGPU, embedded processor, or the like. In one embodiment, controller hub 1520 may include an integrated graphics accelerator.

There can be a variety of differences between the physical resources 1510, 1515 in terms of a spectrum of metrics of merit including architectural, microarchitectural, thermal, power consumption characteristics, and the like.

In one embodiment, the processor 1510 executes instructions that control data processing operations of a general type. Embedded within the instructions may be coprocessor instructions. The processor 1510 recognizes these coprocessor instructions as being of a type that should be executed by the attached coprocessor 1545. Accordingly, the processor 1510 issues these coprocessor instructions (or control signals representing coprocessor instructions) on a coprocessor bus or other interconnect, to coprocessor 1545. Coprocessor(s) 1545 accepts and executes the received coprocessor instructions.

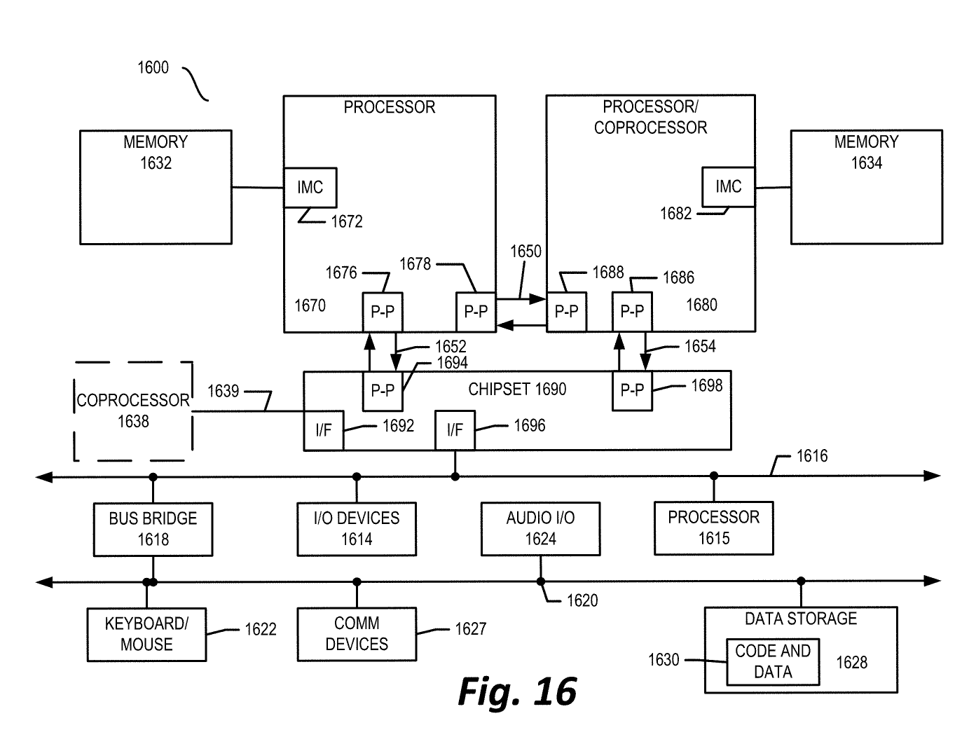

Referring now to FIG. 16, shown is a block diagram of a first more specific example system 1600. As shown in FIG. 16, multiprocessor system 1600 is a point-to-point interconnect system, and includes a first processor 1670 and a second processor 1680 coupled via a point-to-point interconnect 1650. Each of processors 1670 and 1680 may be some version of the processor 1400. In one embodiment, processors 1670 and 1680 are respectively processors 1510 and 1515, while coprocessor 1638 is coprocessor 1545. In another embodiment, processors 1670 and 1680 are respectively processor 1510 coprocessor 1545.

Processors 1670 and 1680 are shown including integrated memory controller (IMC) units 1672 and 1682, respectively. Processor 1670 also includes as part of its bus controller units point-to-point (P-P) interfaces 1676 and 1678; similarly, second processor 1680 includes P-P interfaces 1686 and 1688. Processors 1670, 1680 may exchange information via a point-to-point (P-P) interface 1650 using P-P interface circuits 1678, 1688. As shown in FIG. 16, IMCs 1672 and 1682 couple the processors to respective memories, namely a memory 1632 and a memory 1634, which may be portions of main memory locally attached to the respective processors.

Processors 1670, 1680 may each exchange information with a chipset 1690 via individual P-P interfaces 1652, 1654 using point to point interface circuits 1676, 1694, 1686, 1698. Chipset 1690 may optionally exchange information with the coprocessor 1638 via a high-performance interface 1639. In one embodiment, the coprocessor 1638 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1690 may be coupled to a first bus 1616 via an interface 1696. In one embodiment, first bus 1616 may be a peripheral component interconnect (PCI) bus, or a bus such as a PCI Express bus or another third generation IO interconnect bus, by way of nonlimiting example.

As shown in FIG. 16, various IO devices 1614 may be coupled to first bus 1616, along with a bus bridge 1618 which couples first bus 1616 to a second bus 1620. In one embodiment, one or more additional processor(s) 1615, such as coprocessors, high-throughput MIC processors, GPGPUs, accelerators (such as, e.g., graphics accelerators or digital signal processing (DSP) units), field programmable gate arrays, or any other processor, are coupled to first bus 1616. In one embodiment, second bus 1620 may be a low pin count (LPC) bus. Various devices may be coupled to a second bus 1620 including, for example, a keyboard and/or mouse 1622, communication devices 1627 and a storage unit 1628 such as a disk drive or other mass storage device which may include instructions or code and data 1630, in one embodiment. Further, an audio IO 1624 may be coupled to the second bus 1620. Note that other architectures are possible. For example, instead of the point-to-point architecture of FIG. 16, a system may implement a multidrop bus or other such architecture.

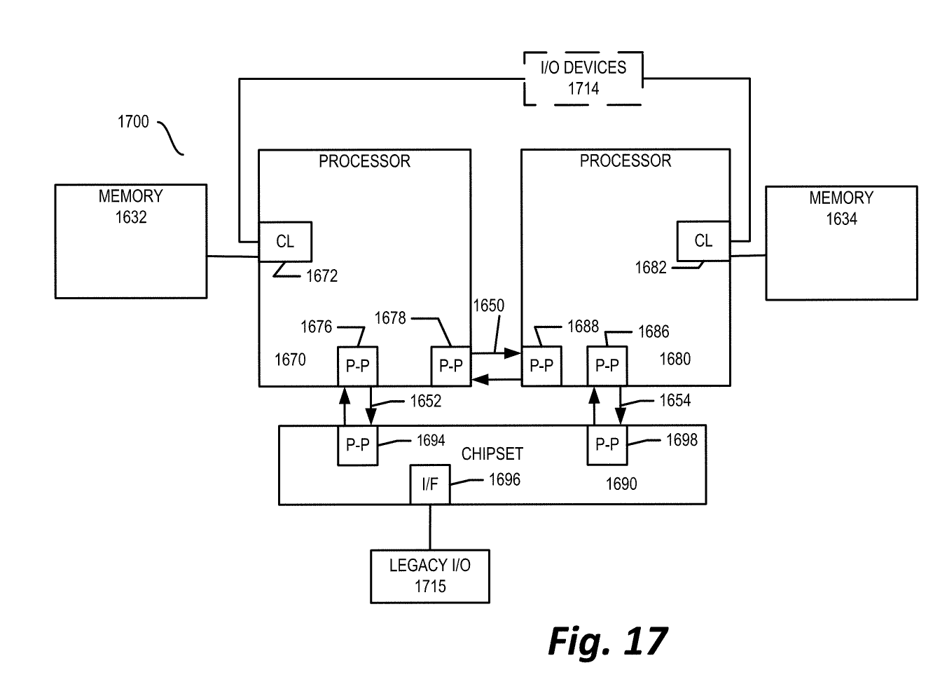

Referring now to FIG. 17, shown is a block diagram of a second more specific example system 1700. FIGS. 16 and 17 bear like reference numerals, and certain aspects of FIG. 16 have been omitted from FIG. 17 in order to avoid obscuring other aspects of FIG. 17.

FIG. 17 illustrates that the processors 1670, 1680 may include integrated memory and IO control logic (“CL”) 1672 and 1682, respectively. Thus, the CL 1672, 1682 include integrated memory controller units and include IO control logic. FIG. 17 illustrates that not only are the memories 1632, 1634 coupled to the CL 1672, 1682, but also that IO devices 1714 are also coupled to the control logic 1672, 1682. Legacy IO devices 1715 are coupled to the chipset 1690.

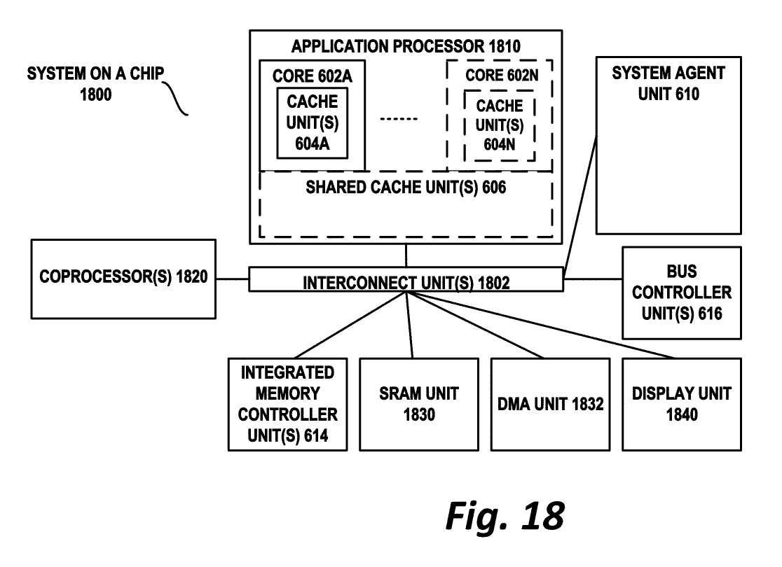

Referring now to FIG. 18, shown is a block diagram of a SoC 1800 in accordance with an embodiment. Similar elements in FIG. 14 bear like reference numerals. Also, dashed lined boxes are optional features on more advanced SoCs. In FIG. 18, an interconnect unit(s) 1802 is coupled to: an application processor 1810 which includes a set of one or more cores 1402A-N and shared cache unit(s) 1406; a system agent unit 1410; a bus controller unit(s) 1416; an integrated memory controller unit(s) 1414; a set of one or more coprocessors 1820 which may include integrated graphics logic, an image processor, an audio processor, and a video processor; a static random access memory (SRAM) unit 1830; a direct memory access (DMA) unit 1832; and a display unit 1840 for coupling to one or more external displays. In one embodiment, the coprocessor(s) 1820 includes a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Some embodiments may be implemented as computer programs or program code executing on programmable systems comprising at least one processor, a storage system (including volatile and nonvolatile memory and/or storage elements), at least one input device, and at least one output device.

Program code, such as code 1630 illustrated in FIG. 16, may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application-specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, nontransitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, some embodiments also include nontransitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation or dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

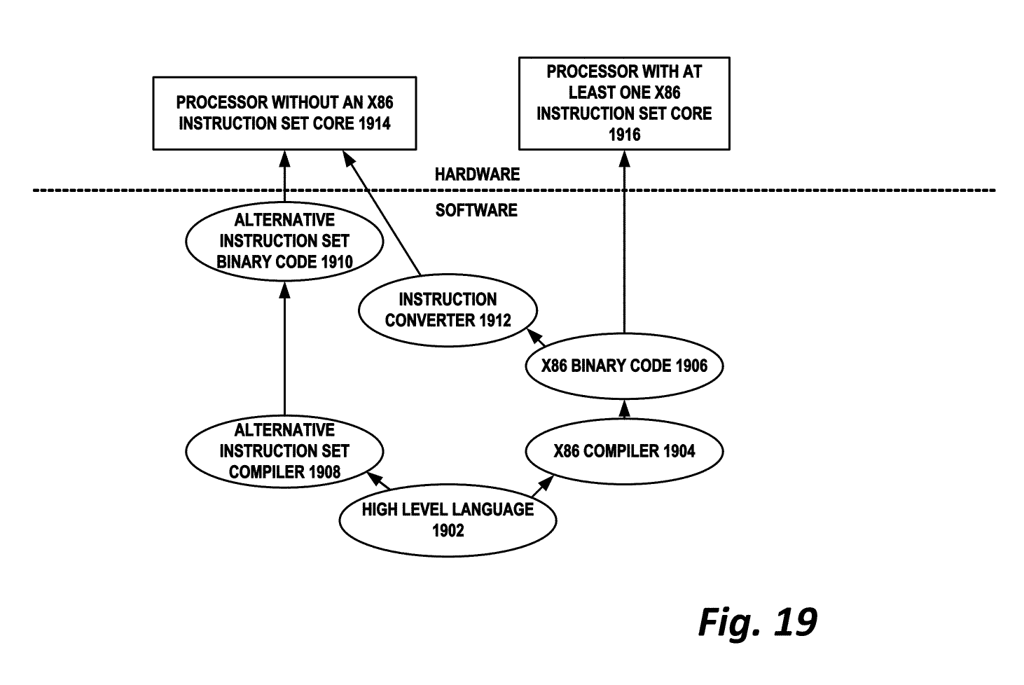

FIG. 19 is a block diagram contrasting the use of a software instruction converter to convert binary instructions in a source instruction set to binary instructions in a target instruction set. In the illustrated embodiment, the instruction converter is a software instruction converter, although alternatively the instruction converter may be implemented in software, firmware, hardware, or various combinations thereof. FIG. 19 shows a program in a high level language 1902 may be compiled using an x86 compiler 1904 to generate x86 binary code 1906 that may be natively executed by a processor with at least one x86 instruction set core 1916. The processor with at least one x86 instruction set core 1916 represents any processor that can perform substantially the same functions as an Intel® processor with at least one x86 instruction set core by compatibly executing or otherwise processing (1) a substantial portion of the instruction set of the Intel® x86 instruction set core or (2) object code versions of applications or other software targeted to run on an Intel® processor with at least one x86 instruction set core, in order to achieve substantially the same result as an Intel® processor with at least one x86 instruction set core. The x86 compiler 1904 represents a compiler that is operable to generate x86 binary code 1906 (e.g., object code) that can, with or without additional linkage processing, be executed on the processor with at least one x86 instruction set core 1916. Similarly, FIG. 19 shows the program in the high level language 1902 may be compiled using an alternative instruction set compiler 1908 to generate alternative instruction set binary code 1910 that may be natively executed by a processor without at least one x86 instruction set core 1914 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1912 is used to convert the x86 binary code 1906 into code that may be natively executed by the processor without an x86 instruction set core 1914. This converted code is not likely to be the same as the alternative instruction set binary code 1910 because an instruction converter capable of this is difficult to make; however, the converted code will accomplish the general operation and be made up of instructions from the alternative instruction set. Thus, the instruction converter 1912 represents software, firmware, hardware, or a combination thereof that, through emulation, simulation or any other process, allows a processor or other electronic device that does not have an x86 instruction set processor or core to execute the x86 binary code 1906.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), field-programmable gate arrays (FPGAs), and other semiconductor chips.

As used throughout this specification, the term “processor” or “microprocessor” should be understood to include not only a traditional microprocessor (such as Intel'S® industry-leading x86 and x64 architectures), but also any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field-programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, nontransitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A nontransitory storage medium herein is expressly intended to include any nontransitory special-purpose or programmable hardware configured to provide the disclosed operations, or to cause a processor to perform the disclosed operations. A nontransitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. section 912, as it exists on the date of the filing hereof, unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

There is disclosed in one example, a processor, comprising: an execution unit comprising branching circuitry; a branch predictor, comprising a hard-to-predict (HTP) branch filter to identify a HTP branch; and a special branch predictor to receive identification of an HTP branch from the HTP branch filter, the special branch predictor comprising a convolutional neural network (CNN) branch predictor to predict a branching action for the HTP branch.

There is further disclosed an example of a processor, wherein the special branch predictor comprises a co-processor or field-programmable gate array.

There is further disclosed an example of a processor, wherein the special branch predictor is an on-die circuit block.

There is further disclosed an example of a processor, wherein the special branch predictor is to employ simplified one-hot binary circuitry.

There is further disclosed an example of a processor, wherein the special branch predictor comprises a two-layer CNN.

There is further disclosed an example of a processor, wherein the special branch predictor comprises a binary 1-D convolution layer and a fully-connected binary layer.

There is further disclosed an example of a processor, wherein the 1-D convolution layer is to receive an incoming (program counter (PC), direction) pair, mask the incoming pair, use the masked bits as an index to a filter response table, and return an L-bit vector as a response.

There is further disclosed an example of a processor, wherein the 1-D convolution layer is further to push the response into an N×L-bit first-in-first-out (FIFO) buffer.

There is further disclosed an example of a processor, wherein the fully-connected binary layer is to XOR contents of the FIFO buffer with binary linear-layer weights, and count the resulting number of 1's as an integer total.

There is further disclosed an example of a processor, wherein the fully-connected binary layer is further to compare the integer total to generate a taken-or-not-taken branch prediction.

There is further disclosed an example of a processor, wherein the special branch predictor is to receive metadata from a trained CNN.

There is further disclosed an example of a processor, wherein the special branch predictor further comprises a CNN helper predictor.

There is also disclosed an example of a system-on-a-chip, comprising: input-output circuitry; a memory to contain a program, the program including branching circuitry; and a processor, comprising: an execution unit comprising branching circuitry; a branch predictor, comprising a hard-to-predict (HTP) branch filter to identify a HTP branch; and a special branch predictor to receive identification of an HTP branch from the HTP branch filter, the special branch predictor comprising a convolutional neural network (CNN) branch predictor to predict a branching action for the HTP branch.

There is further disclosed an example of a system-on-a-chip, wherein the special branch predictor comprises a co-processor or field-programmable gate array.

There is further disclosed an example of a system-on-a-chip, wherein the special branch predictor is an on-die circuit block.

There is further disclosed an example of a system-on-a-chip, wherein the special branch predictor is to employ simplified one-hot binary circuitry.

There is further disclosed an example of a system-on-a-chip, wherein the special branch predictor comprises a two-layer CNN.

There is further disclosed an example of a system-on-a-chip, wherein the special branch predictor comprises a binary 1-D convolution layer and a fully-connected binary layer.

There is further disclosed an example of a system-on-a-chip, wherein the 1-D convolution layer is to receive an incoming (program counter (PC), direction) pair, mask the incoming pair, use the masked bits as an index to a filter response table, and return an L-bit vector as a response.

There is further disclosed an example of a system-on-a-chip, wherein the 1-D convolution layer is further to push the response into an N×L-bit first-in-first-out (FIFO) buffer.

There is further disclosed an example of a system-on-a-chip, wherein the fully-connected binary layer is to XOR contents of the FIFO buffer with binary linear-layer weights, and count the resulting number of 1's as an integer total.

There is further disclosed an example of a system-on-a-chip, wherein the fully-connected binary layer is further to compare the integer total to a threshold to generate a taken-or-not-taken branch prediction.

There is further disclosed an example of a system-on-a-chip, wherein the special branch predictor is to receive metadata from a trained CNN.

There is further disclosed an example of a system-on-a-chip, wherein the special branch predictor further comprises a CNN helper predictor.

There is also disclosed an example of a computer-implemented method of performing hard-to-predict (HTP) branching prediction, comprising: applying a branching filter to branching circuitry to identify a HTP branch; and predicting a branching action for the HTP branch according to a convolutional neural network (CNN) algorithm.

There is further disclosed an example of a computer-implemented method, wherein the CNN algorithm includes simplified one-hot binary circuitry.

There is further disclosed an example of a computer-implemented method, wherein the CNN algorithm is a two-layer CNN algorithm.

There is further disclosed an example of a computer-implemented method, wherein the two-layer CNN algorithm comprises a binary 1-D convolution layer and a fully-connected binary layer.

There is further disclosed an example of a computer-implemented method, wherein the 1-D convolution layer is to receive an incoming (program counter (PC), direction) pair, mask the incoming pair, use the masked bits as an index to a filter response table, and return an L-bit vector as a response.

There is further disclosed an example of a computer-implemented method, wherein the 1-D convolution layer is further to push the response into an N×L-bit first-in-first-out (FIFO) buffer.

There is further disclosed an example of a computer-implemented method, wherein the fully-connected binary layer is to XOR contents of the FIFO buffer with binary linear-layer weights, and count the resulting number of 1's as an integer total.

There is further disclosed an example of a computer-implemented method, further comprising comparing the integer total to a threshold to generate a taken-or-not-taken branch prediction.

There is further disclosed an example of a computer-implemented method, further comprising training the CNN algorithm according to metadata from a trained CNN.

There is further disclosed an example of an apparatus comprising means for performing the method of a number of the above examples.

There is further disclosed an example of an apparatus, wherein the means comprise a microprocessor comprising a special branch predictor.

There is further disclosed an example of an apparatus, wherein the special branch predictor comprises an on-die circuit block.

There is further disclosed an example of an apparatus, wherein the special branch predictor comprises a co-processor or a field-programmable gate array.

There is further disclosed an example of a system-on-a-chip comprising the apparatus of a number of the above examples.

There is further disclosed an example of an apparatus, further comprising a CNN helper predictor.

There is also disclosed an example of a method of performing branch prediction, comprising: identifying a hard-to-predict (HTP) branch of a program; and accessing a convolutional neural network (CNN) branch predictor to predict a branching action for the HTP branch.

There is further disclosed an example of a method, wherein accessing the CNN branch predictor comprises employing simplified one-hot binary circuitry.

There is further disclosed an example of a method, wherein the CNN branch predictor comprises a two-layer CNN.

There is further disclosed an example of a method, wherein the CNN branch predictor comprises a binary 1-D convolution layer and a fully-connected binary layer.

There is further disclosed an example of a method, wherein the 1-D convolution layer is to receive an incoming (program counter (PC), direction) pair, mask the incoming pair, use the masked bits as an index to a filter response table, and return an L-bit vector as a response.

There is further disclosed an example of a method, wherein the 1-D convolution layer is further to push the response into an N×L-bit first-in-first-out (FIFO) buffer.

There is further disclosed an example of a method, wherein the fully-connected binary layer is to XOR contents of the FIFO buffer with binary linear-layer weights, and count the resulting number of 1's as an integer total.

There is further disclosed an example of a method, wherein the fully-connected binary layer is further to compare the integer total to generate a taken-or-not-taken branch prediction.

There is further disclosed an example of a method, further comprising receiving metadata from a trained CNN.

There is further disclosed an example of a method, wherein the CNN branch predictor further comprises a CNN helper predictor.

There is further disclosed an example of an apparatus comprising means for performing the method of a number of the preceding examples.

There is further disclosed an example of an apparatus, wherein the means for performing the method comprise a processor comprising a branch predictor and a special branch predictor, the special branch predictor comprising the CNN branch predictor.

There is further disclosed an example of an apparatus, wherein the special branch predictor is a co-processor.

There is further disclosed an example of an apparatus, wherein the special branch predictor is a hardware accelerator.

There is further disclosed an example of an apparatus, wherein the apparatus is a computing system.

There is further disclosed an example of at least one computer readable medium comprising instructions that, when executed, implement a method or realize an apparatus as claimed in a number of the preceding examples.

What is claimed is:

1. A processor, comprising:
an execution unit comprising branching circuitry;
a branch predictor, comprising a hard-to-predict (HTP) branch filter to identify an HTP branch; and
a special branch predictor to receive identification of an HTP branch from the HTP branch filter, the special branch predictor comprising a convolutional neural network (CNN) branch predictor to predict a branching action for the HTP branch.

2. The processor of claim 1, wherein the special branch predictor comprises a co-processor or field-programmable gate array.

3. The processor of claim 1, wherein the special branch predictor is an on-die circuit block.

4. The processor of claim 1, wherein the special branch predictor is to employ simplified one-hot binary circuitry.

5. The processor of claim 1, wherein the special branch predictor comprises a two-layer CNN.

6. The processor of claim 5, wherein the special branch predictor comprises a binary 1-D convolution layer and a fully-connected binary layer.

7. The processor of claim 6, wherein the 1-D convolution layer is to receive an incoming (program counter (PC), direction) pair, mask the incoming pair, use the masked bits as an index to a filter response table, and return an L-bit vector as a response.

8. The processor of claim 7, wherein the 1-D convolution layer is further to push the response into an N×L-bit first-in-first-out (FIFO) buffer.

9. The processor of claim 8, wherein the fully-connected binary layer is to XOR contents of the FIFO buffer with binary linear-layer weights, and count the resulting number of 1's as an integer total.

10. The processor of claim 9, wherein the fully-connected binary layer is further to compare the integer total to generate a taken-or-not-taken branch prediction.

11. The processor of claim 1, wherein the special branch predictor is to receive metadata from a trained CNN.

12. The processor of claim 1, wherein the special branch predictor further comprises a CNN helper predictor.

13. A system-on-a-chip, comprising:
input-output circuitry;
a memory to contain a program, the program including branching circuitry; and
a processor, comprising:
an execution unit comprising branching circuitry;
a branch predictor, comprising a hard-to-predict (HTP) branch filter to identify a HTP branch; and
a special branch predictor to receive identification of an HTP branch from the HTP branch filter, the special branch predictor comprising a convolutional neural network (CNN) branch predictor to predict a branching action for the HTP branch.

14. The system-on-a-chip of claim 13, wherein the special branch predictor comprises a co-processor or field-programmable gate array.

15. The system-on-a-chip of claim 13, wherein the special branch predictor is an on-die circuit block.

16. The system-on-a-chip of claim 13, wherein the special branch predictor is to employ simplified one-hot binary circuitry.

17. The system-on-a-chip of claim 13, wherein the special branch predictor comprises a two-layer CNN.

18. The system-on-a-chip of claim 17, wherein the special branch predictor comprises a binary 1-D convolution layer and a fully-connected binary layer.

19. The system-on-a-chip of claim 18, wherein the 1-D convolution layer is to receive an incoming (program counter (PC), direction) pair, mask the incoming pair, use the masked bits as an index to a filter response table, and return an L-bit vector as a response.

20. The system-on-a-chip of claim 19, wherein the 1-D convolution layer is further to push the response into an N×L-bit first-in-first-out (FIFO) buffer.

21. The system-on-a-chip of claim 20, wherein the fully-connected binary layer is to XOR contents of the FIFO buffer with binary linear-layer weights, and count the resulting number of 1's as an integer total.

22. The system-on-a-chip of claim 21, wherein the fully-connected binary layer is further to compare the integer total to a threshold to generate a taken-or-not-taken branch prediction.

23. The system-on-a-chip of claim 13, wherein the special branch predictor is to receive metadata from a trained CNN.

24. The system-on-a-chip of claim 13, wherein the special branch predictor further comprises a CNN helper predictor.

25. A computer-implemented method of performing hard-to-predict (HTP) branching prediction, comprising:
applying a branching filter to branching circuitry to identify a HTP branch; and
predicting a branching action for the HTP branch according to a convolutional neural network (CNN) algorithm.
